(19) United States
(12) Patent Application Publication
(10) Pub. No.: US 2026/0262006 A1
(43) Pub. Date: Sep. 3, 2026

(54) POSITIONING REFERENCE SIGNALS VIA WAKE-UP SIGNALS

(71) Applicant: QUALCOMM Incorporated, San Diego, CA (US)

(72) Inventors: Weimin DUAN, San Diego, CA (US); Huilin XU, Temecula, CA (US); Jing LEI, San Diego, CA (US)

(21) Appl. No.: 19/069,199

(22) Filed: Mar. 3, 2025

(51) Int. Cl. H04W 64/00; H04L 5/00; H04W 24/08

(52) U.S. Cl. CPC H04W 64/00; H04L 5/0048; H04W 24/08

(57) ABSTRACT

Some examples of the techniques described herein may provide at least one overlaid positioning reference signal (PRS) for a wake-up signal (WUS) to achieve additional functionality, which may reduce resource overhead or network energy consumption. With an overlaid PRS, a user equipment (UE) may have more flexibility in implementation to achieve different trade-offs between performance and power consumption. For example, if a UE operates in a power-saving state (e.g., inactive mode, idle mode, sleep more, or low power mode, among other examples), the UE may use an on-off keying (OOK) detector with low power consumption. The UE may switch back to a relatively higher power mode with an IQ-based receiver for improved performance. Some examples of the techniques described may achieve energy saving for the network side or the UE side.

### FIELD OF TECHNOLOGY

The following relates to wireless communications, including positioning reference signals via wake-up signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a wireless device is described. The method may include receiving a wake-up signal (WUS) that includes an on-off keying (OOK) symbol, where the OOK symbol includes at least a portion of a positioning reference signal (PRS) and determining a position measurement based on the at least a portion of the PRS.

A wireless device is described. The wireless device may include one or more transceivers, one or more memory, and one or more processors coupled to the one or more memory and the one or more transceivers. The one or more processors may be configured to receive a WUS that includes an OOK symbol, where the OOK symbol includes at least a portion of a PRS and determine a position measurement based on the at least a portion of the PRS.

Another wireless device is described. The wireless device may include means for receiving a WUS that includes an OOK symbol, where the OOK symbol includes at least a portion of a PRS and means for determining a position measurement based on the at least a portion of the PRS.

A non-transitory computer-readable medium storing code is described. The code may include instructions executable by one or more processors to receive a WUS that includes an OOK symbol, where the OOK symbol includes at least a portion of a PRS and determine a position measurement based on the at least a portion of the PRS.

Some examples of the method, wireless devices, and non-transitory computer-readable medium described herein may further include one or more operations, features, means, instructions, or processors for generating information based on the position measurement of the at least a portion of the PRS and transmitting, to a network entity, the information that may be based on the position measurement of the PRS.

In some examples of the method, wireless devices, and non-transitory computer-readable medium described herein, the at least a portion of the PRS may be carried on one or more OOK symbols with an on state in a duration of an orthogonal frequency division multiplexing (OFDM) symbol.

In some examples of the method, wireless devices, and non-transitory computer-readable medium described herein, the OOK symbol may have a same duration as an OFDM symbol, and the at least a portion of the PRS may be modulated in a frequency domain on one or more subcarriers for the WUS.

In some examples of the method, wireless devices, and non-transitory computer-readable medium described herein, the OOK symbol may have a shorter duration than an OFDM symbol, and the at least a portion of the PRS may be a signal generated in a time domain.

In some examples of the method, wireless devices, and non-transitory computer-readable medium described herein, the OOK symbol may have a shorter duration than an OFDM symbol, and the at least a portion of the PRS may be modulated in a frequency domain with a first subcarrier spacing (SCS) that may be M times a second SCS of the OFDM symbol.

In some examples of the method, wireless devices, and non-transitory computer-readable medium described herein, multiple PRSs may be time-division multiplexed in the WUS or across multiple WUSs.

In some examples of the method, wireless devices, and non-transitory computer-readable medium described herein, a first PRS of the multiple PRSs corresponds to a first cell and a second PRS of the multiple PRSs corresponds to a second cell and the first PRS may be communicated via a first quantity of OOK symbols and the second PRS may be communicated via a second quantity of OOK symbols that may be different from the first quantity of symbols.

In some examples of the method, wireless devices, and non-transitory computer-readable medium described herein, the at least a portion of the PRS spans a single OOK symbol, multiple OOK symbols, or all OOK symbols of the WUS.

In some examples of the method, wireless devices, and non-transitory computer-readable medium described herein, the at least a portion of the PRS may be frequency-division multiplexed on the WUS in accordance with a comb.

In some examples of the method, wireless devices, and non-transitory computer-readable medium described herein, a resource for communication of PRS signaling repeats based on a quantity of OOK symbols, a quantity of OFDM symbols, a quantity of slots, or a quantity of WUS repetitions.

Some examples of the method, wireless devices, and non-transitory computer-readable medium described herein may further include one or more operations, features, means, instructions, or processors for outputting, to a network entity, a request for the WUS that includes the OOK symbol that includes the at least a portion of the PRS, where the WUS may be received based on the request.

Some examples of the method, wireless devices, and non-transitory computer-readable medium described herein may further include one or more operations, features, means, instructions, or processors for outputting, to a network entity, capability information indicating a capability of the wireless device to receive the WUS that includes the OOK symbol that includes the at least a portion of the PRS.

Some examples of the method, wireless devices, and non-transitory computer-readable medium described herein may further include one or more operations, features, means, instructions, or processors for obtaining, from a network entity, configuration information indicating that the wireless device may be to receive the WUS that includes the OOK symbol that includes the at least a portion of the PRS.

A method by a network node is described. The method may include transmitting a WUS that includes an OOK symbol, where the OOK symbol includes at least a portion of a PRS and receiving information that is based on a position measurement of the at least a portion of the PRS.

A network node is described. The network node may include one or more transceivers, one or more memory, and one or more processors coupled to the one or more memory and the one or more transceivers. The one or more processors may be configured to transmit a WUS that includes an OOK symbol, where the OOK symbol includes at least a portion of a PRS and receive information that is based on a position measurement of the at least a portion of the PRS.

Another network node is described. The network node may include means for transmitting a WUS that includes an OOK symbol, where the OOK symbol includes at least a portion of a PRS and means for receiving information that is based on a position measurement of the at least a portion of the PRS.

A non-transitory computer-readable medium storing code is described. The code may include instructions executable by one or more processors to transmit a WUS that includes an OOK symbol, where the OOK symbol includes at least a portion of a PRS and receive information that is based on a position measurement of the at least a portion of the PRS.

In some examples of the method, network nodes, and non-transitory computer-readable medium described herein, the at least a portion of the PRS may be carried on one or more OOK symbols with an on state in a duration of an OFDM symbol.

In some examples of the method, network nodes, and non-transitory computer-readable medium described herein, the OOK symbol may have a same duration as an OFDM symbol, and the at least a portion of the PRS may be modulated in a frequency domain on one or more subcarriers for the WUS.

In some examples of the method, network nodes, and non-transitory computer-readable medium described herein, the OOK symbol may have a shorter duration than an OFDM symbol, and the at least a portion of the PRS may be a signal generated in a time domain.

In some examples of the method, network nodes, and non-transitory computer-readable medium described herein, the OOK symbol may have a shorter duration than an OFDM symbol, and the at least a portion of the PRS may be modulated in a frequency domain with a first SCS that may be M times a second SCS of the OFDM symbol.

In some examples of the method, network nodes, and non-transitory computer-readable medium described herein, multiple PRSs may be time-division multiplexed in the WUS or across multiple WUSs.

In some examples of the method, network nodes, and non-transitory computer-readable medium described herein, a first PRS of the multiple PRSs corresponds to a first cell and a second PRS of the multiple PRSs corresponds to a second cell and the first PRS may be communicated via a first quantity of OOK symbols and the second PRS may be communicated via a second quantity of OOK symbols that may be different from the first quantity of symbols.

In some examples of the method, network nodes, and non-transitory computer-readable medium described herein, the at least a portion of the PRS spans a single OOK symbol, multiple OOK symbols, or all OOK symbols of the WUS.

In some examples of the method, network nodes, and non-transitory computer-readable medium described herein, the at least a portion of the PRS may be frequency-division multiplexed on the WUS in accordance with a comb.

In some examples of the method, network nodes, and non-transitory computer-readable medium described herein, a resource for communication of PRS signaling repeats based on a quantity of OOK symbols, a quantity of OFDM symbols, a quantity of slots, or a quantity of WUS repetitions.

Some examples of the method, network nodes, and non-transitory computer-readable medium described herein may further include one or more operations, features, means, instructions, or processors for outputting, to a network entity, capability information indicating that the network node may be capable of transmitting the at least a portion of the PRS included in the OOK symbol of the WUS.

Some examples of the method, network nodes, and non-transitory computer-readable medium described herein may further include one or more operations, features, means, instructions, or processors for outputting, to a network entity, an indication of a periodicity of PRS signaling on WUS signaling that the network node may be capable of transmitting, an indication of a type of PRS signaling on WUS signaling that the network node may be capable of transmitting, a bandwidth of PRS signaling on WUS signaling that the network node supports, a duration of WUS signaling via which PRS signaling may be supported by the network node, an indication of one or more activity modes the network node supports for PRS signaling on WUS signaling, or an indication of whether PRS signaling on WUS signaling during a connected mode discontinuous reception (CDRX) may be supported by the network node, or any combination thereof.

Some examples of the method, network nodes, and non-transitory computer-readable medium described herein may further include one or more operations, features, means, instructions, or processors for obtaining, from a network entity, a request for an indication of a pattern of the WUS corresponding to a wireless device and outputting, to the network entity, the indication of the pattern of the WUS corresponding to the wireless device based on the request.

Some examples of the method, network nodes, and non-transitory computer-readable medium described herein may further include one or more operations, features, means, instructions, or processors for obtaining, from a network entity, a request that the network node transmit the at least a portion of the PRS in accordance with a pattern, where transmitting the WUS that includes the OOK symbol may be based on the pattern.

A method by a network entity is described. The method may include obtaining, from a network node, capability information indicating that the network node is capable of transmitting at least a portion of a PRS included in an OOK symbol of a WUS and outputting, to the network node, configuration information indicating that the network node is to transmit the at least a portion of the PRS included in the OOK symbol of the WUS.

A network entity is described. The network entity may include one or more transceivers, one or more memory, and one or more processors coupled to the one or more memory and the one or more transceivers. The one or more processors may be configured to obtain, from a network node, capability information indicating that the network node is capable of transmitting at least a portion of a PRS included in an OOK symbol of a WUS and output, to the network node, configuration information indicating that the network node is to transmit the at least a portion of the PRS included in the OOK symbol of the WUS.

Another network entity is described. The network entity may include means for obtaining, from a network node, capability information indicating that the network node is capable of transmitting at least a portion of a PRS included in an OOK symbol of a WUS and means for outputting, to the network node, configuration information indicating that the network node is to transmit the at least a portion of the PRS included in the OOK symbol of the WUS.

A non-transitory computer-readable medium storing code is described. The code may include instructions executable by one or more processors to obtain, from a network node, capability information indicating that the network node is capable of transmitting at least a portion of a PRS included in an OOK symbol of a WUS and output, to the network node, configuration information indicating that the network node is to transmit the at least a portion of the PRS included in the OOK symbol of the WUS.

Some examples of the method, network entities, and non-transitory computer-readable medium described herein may further include one or more operations, features, means, instructions, or processors for receiving information that may be based on a position measurement of the at least a portion of the PRS.

In some examples of the method, network entities, and non-transitory computer-readable medium described herein, the capability information includes an indication of a periodicity of PRS signaling on WUS signaling that the network node may be capable of transmitting, an indication of a type of PRS signaling on WUS signaling that the network node may be capable of transmitting, a bandwidth of PRS signaling on WUS signaling that the network node supports, a duration of WUS signaling via which PRS signaling may be supported by the network node, an indication of one or more activity modes the network node supports for PRS signaling on WUS signaling, or an indication of whether PRS signaling on WUS signaling during a CDRX may be supported by the network node, or any combination thereof and the configuration information may be based on the capability information.

Some examples of the method, network entities, and non-transitory computer-readable medium described herein may further include one or more operations, features, means, instructions, or processors for outputting, to the network node, a request for an indication of a pattern of the WUS corresponding to a wireless device and obtaining, from the network node, the indication of the pattern of the WUS corresponding to the wireless device based on the request.

Some examples of the method, network entities, and non-transitory computer-readable medium described herein may further include one or more operations, features, means, instructions, or processors for outputting, to the network node, a request that the network node transmit the at least a portion of the PRS in accordance with a pattern.

Some examples of the method, network entities, and non-transitory computer-readable medium described herein may further include one or more operations, features, means, instructions, or processors for obtaining, from a wireless device, a request for the WUS that includes the OOK symbol that includes the at least a portion of the PRS, where the configuration information may be output based on the request.

Some examples of the method, network entities, and non-transitory computer-readable medium described herein may further include one or more operations, features, means, instructions, or processors for obtaining, from a wireless device, capability information indicating a capability of the wireless device to receive the WUS that includes the OOK symbol that includes the at least a portion of the PRS.

Some examples of the method, network entities, and non-transitory computer-readable medium described herein may further include one or more operations, features, means, instructions, or processors for outputting, to a wireless device, configuration information indicating that the wireless device may be to receive the WUS that includes the OOK symbol that includes the at least a portion of the PRS.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports positioning reference signals (PRSs) via wake-up signals (WUSs) in accordance with one or more aspects of the present disclosure.

FIG. 2 shows an example of a network structure that supports PRSs via WUSs in accordance with one or more aspects of the present disclosure.

FIG. 3 shows an example of a network architecture that supports PRSs via WUSs in accordance with one or more aspects of the present disclosure.

FIG. 4 shows an example of a wireless communications system that supports PRSs via WUSs in accordance with one or more aspects of the present disclosure.

FIG. 5 shows an example of a block diagram that supports PRSs via WUSs in accordance with one or more aspects of the present disclosure.

FIG. 6 shows examples of timing diagrams that support PRSs via WUSs in accordance with one or more aspects of the present disclosure.

FIG. 7 shows an example of a process flow that supports PRSs via WUSs in accordance with one or more aspects of the present disclosure.

FIG. 8 shows an example of a process flow that supports PRSs via WUSs in accordance with one or more aspects of the present disclosure.

FIGS. 9 and 10 show block diagrams of devices that support PRSs via WUSs in accordance with one or more aspects of the present disclosure.

FIG. 11 shows a block diagram of a communications manager that supports PRSs via WUSs in accordance with one or more aspects of the present disclosure.

FIG. 12 shows a diagram of a system including a device that supports PRSs via WUSs in accordance with one or more aspects of the present disclosure.

FIGS. 13 and 14 show block diagrams of devices that support PRSs via WUSs in accordance with one or more aspects of the present disclosure.

FIG. 15 shows a block diagram of a communications manager that supports PRSs via WUSs in accordance with one or more aspects of the present disclosure.

FIG. 16 shows a diagram of a system including a device that supports PRSs via WUSs in accordance with one or more aspects of the present disclosure.

FIGS. 17 and 18 show block diagrams of devices that support PRSs via WUSs in accordance with one or more aspects of the present disclosure.

FIG. 19 shows a block diagram of a communications manager that supports PRSs via WUSs in accordance with one or more aspects of the present disclosure.

FIG. 20 shows a diagram of a system including a device that supports PRSs via WUSs in accordance with one or more aspects of the present disclosure.

FIGS. 21 through 26 show flowcharts illustrating methods that support PRSs via WUSs in accordance with one or more aspects of the present disclosure.

FIG. 27 shows examples of wireless communications systems that support PRSs via WUSs in accordance with one or more aspects of the present disclosure.

### DETAILED DESCRIPTION

Some wireless communications systems may communicate a wake-up signal (WUS) (e.g., a low-power WUS (LP-WUS)) via a wake-up radio (WUR) (e.g., a low-power WUR (LP-WUR)), which may enable wireless devices to exit a power-saving state (e.g., inactive mode, idle mode, or sleep mode, among other examples) for conserving power. The WUR may be active during one or more activity states (e.g., active mode, inactive mode, or idle mode, among other examples). Overlaid sequences in a WUS may provide flexibility for user equipment (UE) implementation of a WUR to achieve a trade-off between power consumption and spectrum efficiency. An in-phase and quadrature (IQ)-based WUR may have a relatively lower noise floor (NF) or higher processing gain due to coherent detection than an on-off keying (OOK) based receiver. An information data rate of overlaid sequences may be higher than the OOK signals when the two achieve similar coverage.

Some examples of the techniques described herein may provide at least one overlaid positioning reference signal (PRS) for a WUS to achieve additional functionality, which may reduce resource overhead or network energy consumption. With an overlaid PRS, a UE may have more flexibility in implementation to achieve different trade-offs between performance and power consumption. For example, if a UE operates in a power-saving state (e.g., inactive mode, idle mode, sleep more, or low power mode, among other examples), the UE may use an OOK detector with low power consumption, where some performance degradation may be tolerable for some use cases or scenarios. The UE may switch back to a relatively higher power mode with an IQ-based receiver for improved performance. Some examples of the techniques described may achieve energy saving for the network side or the UE side. In some networks or deployments, communications may be a significant service provided by network operators. PRSs for positioning may consume resources (e.g., communication spectrum or power, among other examples) or may lack cost efficiency. Communicating a PRS as an overlaid signal on a WUS may provide a communication waveform or reference signal that may support UE positioning, with a reduced impact on the communication use cases.

Aspects of the disclosure are described in the context of wireless communications systems. Aspects of the disclosure are also described in the context of a wireless network structure. Aspects of the disclosure are further described in the context of a network architecture. Aspects of the disclosure are additionally described in the context of a block diagram, a timing diagram, and process flows. Aspects of the disclosure are further illustrated by and described with reference to apparatus diagrams, system diagrams, flowcharts, and block diagrams that relate to PRSs via WUSs.

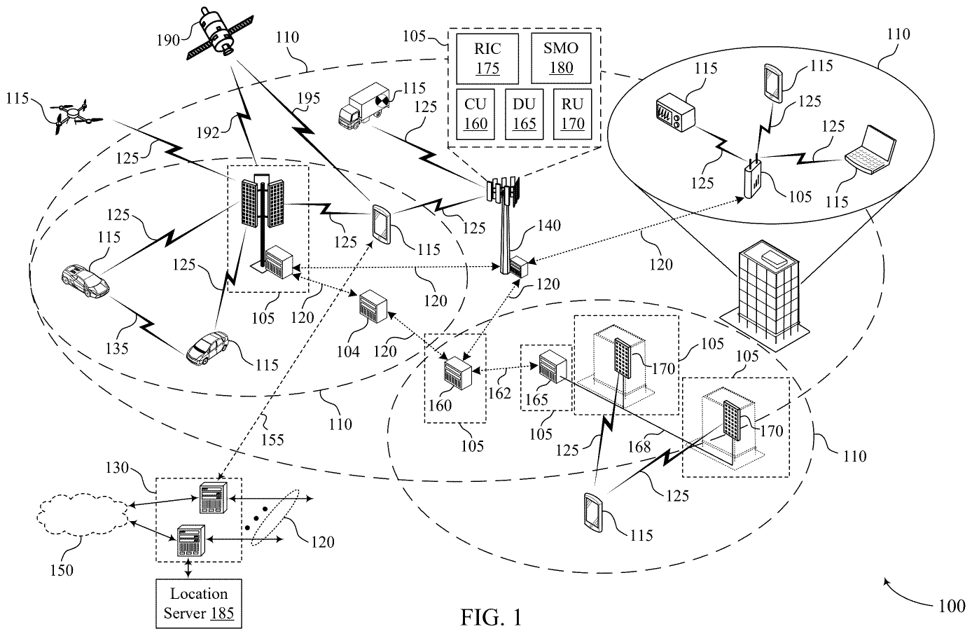

FIG. 1 shows an example of a wireless communications system 100 that supports PRSs via WUSs in accordance with one or more aspects of the present disclosure. The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, an NR network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a network entity, a mobility element, a RAN node, or network equipment, among other nomenclature. In some examples, network nodes 105 and UEs 115 may wirelessly communicate via communication link(s) 125 (e.g., a RF access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or have different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network entity or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be another UE 115. In another aspect of this example, the first node may be a UE 115, the second node may be a network node 105, and the third node may be another network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via wired or wireless backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point (AP), a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a RU, such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a TRP. One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1 interface, F1-c interface, or F1-u, among other examples), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support testing as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network entities (e.g., different ones of the network nodes 105) may be approximately aligned in time. For asynchronous operation, network nodes 105 may have different frame timings, and transmissions from different network entities (e.g., different ones of network nodes 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a D2D communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network entities (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an AMF) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may include a location server 185 (e.g., LMF). The location server 185 may provide positioning, location, or tracking functions. For instance, the location server 185 may participate in one or more positioning procedures to determine a location of (e.g., coordinates of, relative distance(s) to, or an address of) one or more of the UEs 115. Examples of positioning procedures may include one or more operations of assisted global navigation satellite system (A-GNSS), observed time difference of arrival (OTDOA), enhanced cell identifier (E-CID), sensor-based positioning, wireless local area network (WLAN)-based positioning, Bluetooth-based positioning, terrestrial beacon systems (TBS) positioning, downlink time difference of arrival (DL-TDOA), downlink angle of departure (DL-AOD), multi-round-trip time (Multi-RTT), New Radio enhanced cell identifier (NR E-CID), uplink time difference of arrival (UL-TDOA), and uplink angle of arrival (UL-AOA), among other examples. Some examples of the positioning procedures may be managed by, assisted by, or performed with the location server 185. For instance, measurements associated with reference signaling may be provided to the location server 185, which may estimate a location of a UE 115 based on the measurements. In some aspects, the location server 185 may track or store location information corresponding to one or more UEs 115. Some examples of the positioning procedures may be performed without the location server 185.

The location server 185 may be included in the core network 130 or may be separate from the core network 130. In some examples, a location server 185 may be a standalone device or may be included in (e.g., integrated with) a network node 105, a base station 140, a UE 115, a satellite 190, a server, or another device. For instance, the location server 185 may be (or may be included in) a secure user plane location (SUPL) location platform (SLP) device, a third-party server, or another device. The location server 185 may generally refer to a positioning device, a location device, a computing device, or a server, among other examples.

A UE 115 may communicate with the location server 185 directly or indirectly. For example, a UE 115 may communicate with the location server 185 via a network node 105 that is serving the UE 115 and via the core network 130. Additionally, or alternatively, a UE 115 may communicate with the location server 185 through another path (e.g., via an application server) or via another network (e.g., via a WLAN AP), among other examples. Communication between a UE 115 and the location server 185 may be represented via an indirect connection (e.g., through a communication link 125, a network node 105, a communication link 155, a backhaul communication link 120, or the core network 130) or as a direct connection, with one or more intervening nodes (if any) omitted for concision or convenience.

A satellite 190 may be an aerial or space vehicle with signaling capability. In some examples, the wireless communications system 100 may include or communicate with one or more satellites 190. The satellite(s) 190 may be included in one or more satellite positioning systems (e.g., GNSS(s)). A satellite positioning system may include any combination of one or more global or regional navigation satellites associated with one or more satellite positioning systems (e.g., global positioning system (GPS), global navigation satellite system (GLONASS), BeiDou navigation satellite system (BDS), or Galileo, among other examples). A satellite positioning system may include satellites 190 or other transmitters positioned to enable receivers (e.g., UEs 115) to determine a location on or above the Earth based on signals (e.g., the signals 195) received from the satellites 190. For instance, each satellite 190 may transmit a signal 195 marked with a repeating pseudo-random noise (PN) code of a set quantity of chips. In some cases, one or more transmitters located on ground-based control stations, network nodes 105, or UEs 115 may transmit signals for enabling a UE 115 to determine a location.

A UE 115 may include one or more receivers designed to receive the signal(s) 195 from the satellite(s) 190 for determining location information (e.g., a geographic location of the UE 115). For instance, the UE 115 may receive one or more signals 195 from the satellite(s) 190, which may be utilized to determine a location of the UE 115.

In a satellite positioning system, the use of signals 195 may be augmented with one or more satellite-based augmentation systems (SBAS) that may be associated with or enabled for use with one or more global or regional navigation satellite systems. An SBAS may provide integrity information, differential corrections, or other information for use in conjunction with a satellite positioning system. An SBAS may include one or more augmentation systems, such as the Wide Area Augmentation System (WAAS), the European Geostationary Navigation Overlay Service (EGNOS), the Multi-functional Satellite Augmentation System (MSAS), or the GPS Aided Geo Augmented Navigation (GAGAN) system, among other examples.

In some aspects, the satellite(s) 190 may be included in one or more non-terrestrial networks (NTNs). In an NTN, a satellite 190 may communicate with one or more devices (e.g., network entities, ground stations, NTN gateways, or gateways) located on or above the Earth. For example, the satellite 190 may send or receive one or more communications 192 with a network node 105. In some aspects, the communication(s) 192 may include one or more signals relayed to or from a UE 115. Additionally, or alternatively, the satellite 190 may communicate with another terrestrial device that is connected to one or more elements of the wireless communications system 100. For instance, the satellite 190 may communicate with a ground station or NTN gateway, which may provide access to the wireless communications system 100 or one or more other entities (e.g., Internet web servers or one or more other user devices) external to the wireless communications system 100. In some examples, a UE 115 may receive communication signals 195 from the satellite 190 instead of, or in addition to, communication signals from a terrestrial network entity.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize licensed or unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. Devices in the wireless communications system 100 may communicate over unlicensed spectrum, such as the 5 GHz band, the 2.4 GHz band, the 60 GHz band, the 3.6 GHz band, and/or the 900 MHz band. The unlicensed spectrum may also include other frequency bands. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a wireless device (e.g., UE 115) may include an LP-WUR. A network node 105 (e.g., gNB) may transmit a low-power wake-up signal (LP-WUS) to trigger a wireless device (e.g., UE 115) to perform physical downlink control channel (PDCCH) monitoring. An LP-WUS may be referred to as “low-power” due to a signaling design that may allow reception by a relatively simple receiver architecture, such as an envelope detector or sequence detector. In some examples, OOK may be a modulation scheme utilized for the LP-WUS. The LP-WUS may trigger the wireless device to perform PDCCH monitoring for an idle mode, inactive mode, connected mode, or a combination thereof. One or more metrics may be utilized for a LP-WUR. For instance, LP-WUR may measure a low-power signal-to-interference-plus-noise ratio (LP-SINR), a low-power reference signal received power (LP-RSRP), a low-power reference signal received quality (LP-RSRQ), or a low-power received signal strength indicator (LP-RSSI), among other examples. One or more metrics may be utilized for one or more RRM procedures.

Some wireless communications systems may communicate a WUS (e.g., an LP-WUS) via a WUR (e.g., an LP-WUR), which may enable wireless devices (e.g., UEs 115) to exit a power-saving state (e.g., inactive mode, idle mode, or sleep mode, among other examples) for conserving power. The WUR may be active during one or more activity states (e.g., active mode, inactive mode, or idle mode, among other examples). Overlaid sequences in a WUS may provide flexibility for UE 115 implementation of a WUR to achieve a trade-off between power consumption and spectrum efficiency. An IQ-based WUR may have a relatively lower NF or higher processing gain due to coherent detection than an OOK-based receiver. An information data rate of overlaid sequences may be higher than the OOK signals when the two achieve similar coverage.

In some examples of overlaid sequences for a LP-WUS, an overlaid sequence may be transmitted via each “on” symbol duration of one or more OOK signals. In each OOK “on” symbol, for example, random phase signals or an established (e.g., configured) sequence may be transmitted. For random phase signals, the overlaid sequence may flatten the LP-WUS spectrum for enhanced detection performance in frequency selective channels. For an established sequence, the overlaid sequence may carry additional information in the LP-WUS. In some approaches, an overlaid sequence may have one or more properties similar to OFDM signals (e.g., a full bandwidth transmission in the allocated LP-WUS bandwidth, a relatively higher sampling rate with respect to the OOK symbol rate, or a relatively flat spectrum, among other examples).

In some aspects, an overlaid sequence may be generated (or may not be generated) via OFDM modulation with an inverse fast Fourier transform (IFFT). The overlaid sequence may not significantly impact non-coherent envelope detection of an OOK modulated LP-WUS. An IQ receiver-based LP-WUR may detect the overlaid sequence in the time domain without a fast Fourier transform (FFT) or in the frequency domain with an FFT. The IQ receiver may have a relatively lower NF or a relatively higher processing gain than an OOK-based receiver due to coherent detection. In some examples, an information data rate of overlaid sequences may be higher than the information data rate of OOK signals when the overlaid sequences and the OOK signals achieve similar coverage.

In some approaches, an OOK low power synchronization signal (LP-SS) may be utilized for synchronization or RRM measurement. For one or more cells (e.g., nearby or neighboring cells), different LP-SSs may be transmitted such that an LP-WUR avoids synchronizing to downlink timing of a neighbor cell, or such that RRM measurement is not significantly impacted. In some aspects, a quantity (e.g., a maximum quantity) of binary sequences configured for LP-SS may be three for some topologies, four based on the four color theorem, or eight or sixteen if LP-SS can be detected for non-nearest neighbor cells. A binary LP-SS sequence may be down-selected from a Gold sequence, an m-sequence, or a computer-searched sequence. In some aspects, an overlaid sequence may be transmitted during the on duration of an LP-SS. The overlaid sequence may be cell-specific.

An overlaid OFDM sequence may be utilized for an LP-SS in some approaches. An OFDM-based LP-WUR may receive the overlaid OFDM sequences of an LP-SS for synchronization or RRM measurement. In some aspects, an OFDM-based LP-WUR may also process a primary synchronization signal (PSS) or secondary synchronization signal (SSS) from a synchronization signal block (SSB). The LP-SS periodicity (e.g., 320 milliseconds (ms) may be significantly longer than the SSB periodicity (e.g., 20 ms). In some cases, LP-SS overlaid sequences may not be relied upon if an SSB is configured within the bandwidth of the LP-WUS and LP-SS. If an SSB is configured within the LP-WUS or LP-SS bandwidth, synchronization or RRM measurement performance targets may be not defined for LP-SS overlaid sequences. From an implementation perspective, overlaid OFDM sequences may be utilized for LP-WUS and LP-SS (which may share one or more properties, in some cases). For an LP-SS, an overlaid sequence may be transmitted for spectrum flattening. The overlaid sequence may be also cell-specific in some cases.

Some examples of the techniques described herein may provide at least one overlaid PRS for a WUS to achieve additional functionality, which may reduce resource overhead or network energy consumption. With an overlaid PRS, a UE 115 may have more flexibility in implementation to achieve different trade-offs between performance and power consumption. For example, if a UE 115 operates in a power-saving state (e.g., inactive mode, idle mode, sleep more, or low power mode, among other examples), the UE may use an OOK detector with low power consumption, where some performance degradation may be tolerable for some use cases or scenarios. The UE 115 may switch back to a relatively higher power mode with an IQ-based receiver for improved performance. Some examples of the techniques described may achieve energy saving for the network side or the UE side. In some networks or deployments, communications may be a significant service provided by network operators. PRSs for positioning may consume resources (e.g., communication spectrum or power, among other examples) or may lack cost efficiency. Communicating a PRS as an overlaid signal on a WUS may provide a communication waveform or reference signal that may support UE positioning, with a reduced impact on the communication use cases.

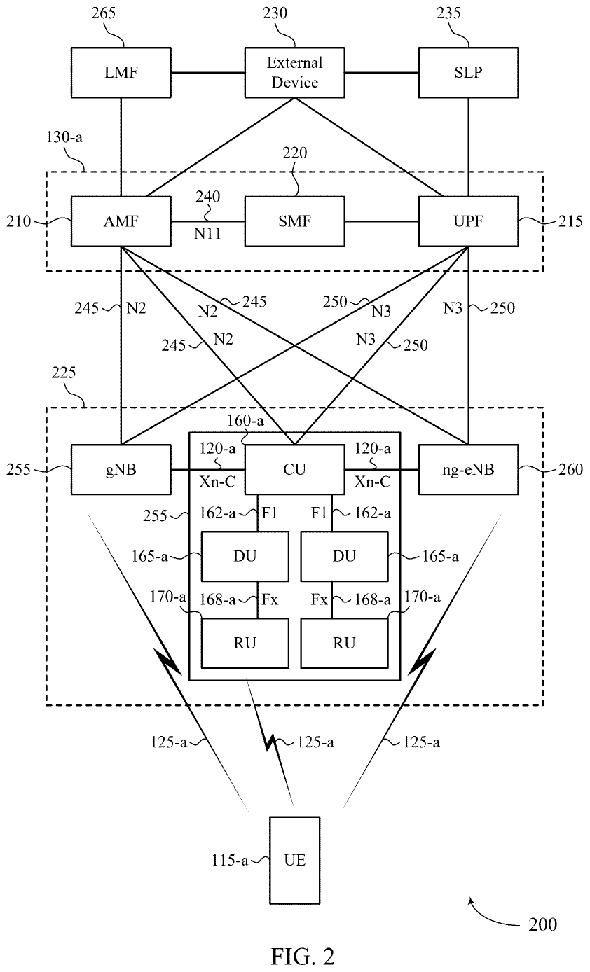

FIG. 2 shows an example of a network structure 200 that supports PRSs via WUSs in accordance with one or more aspects of the present disclosure. The wireless network structure 200 may include a core network 130-a, a RAN 225, a UE 115-a, an LMF 265, an external device 230 (e.g., third-party device or server), or an SLP 235. In some examples, the wireless network structure 200 may be included in the wireless communications system 100 described with reference to FIG. 1. The core network 130-a may be an example of the core network 130, the UE 115-a may be an example of the UEs 115, or the LMF 265 may be an example of the location server 185, as described with reference to FIG. 1.

The core network 130-a may provide one or more control plane (C-plane) functions (e.g., UE registration, authentication, network access, or gateway selection, among other examples) or one or more user plane (U-plane) functions (e.g., UE gateway function, data network access, or IP routing, among other examples). One or more of the functions of the core network 130-a may be implemented in one or more devices (e.g., one or more electronic devices, computing devices, servers, among other examples) in hardware (e.g., circuitry) or a combination of hardware and instructions (e.g., a processor with instructions). The core network 130-a may be an EPC, 5GC, or a Next Generation Core (NGC), among other examples.

The core network 130-a may provide an AMF 210, a session management function (SMF) 220, or a user plane function (UPF) 215. The AMF 210 may provide one or more C-plane functions, such as registration management, connection management, reachability management, mobility management, lawful interception, transport for session management (SM) messages between one or more UEs 115-a and the SMF 220, transparent proxy services for routing SM messages, access authentication and access authorization, transport for short message service (SMS) messages between the UE 115-a and the short message service function (SMSF), or security anchor functionality (SEAF), among other examples. In some aspects, the AMF 210 may interact with an authentication server function (AUSF) and the UE 115-a, and may receive an intermediate key established as a result of a UE 115-a authentication process. In a case of authentication based on a universal mobile telecommunications system (UMTS) subscriber identity module (USIM), the AMF 210 may retrieve security information from the AUSF. In some examples, the AMF 210 may provide a security context management (SCM) function. The SCM function may receive a key from the SEAF that may be utilized to derive access-network specific keys. The AMF 210 may provide location services management for regulatory services, transport for location services messages between the UE 115-a and an LMF 265, transport for location services messages between the RAN 225 and the LMF 265, evolved packet system (EPS) bearer identifier allocation for interworking with the EPS, or UE 115-a mobility event notification. In some approaches, the AMF 210 may support one or more functionalities for Third Generation Partnership Project (3GPP) access networks or non-3GPP access networks.

The UPF 215 may provide one or more U-plane functions, such as acting as an anchor point for intra/inter-RAT mobility, acting as an external protocol data unit (PDU) session point of interconnection to a data network, providing packet routing and forwarding, packet inspection, user plane policy rule enforcement (e.g., gating, redirection, or traffic steering), user plane collection (e.g., interception), traffic usage reporting, quality of service (QoS) handling for the U-plane (e.g., uplink or downlink rate enforcement, reflective QoS marking in the downlink), uplink traffic verification (e.g., service data flow (SDF) to QoS flow mapping), transport level packet marking in the uplink or downlink, downlink packet buffering, downlink data notification triggering, or sending or forwarding one or more indications of an end of a transmission (e.g., “end markers”) to a source RAN node, among other examples. In some examples, the UPF 215 may support the transfer of location services messages over a U-plane between the UE 115-a and another device (e.g., the SLP 235 or the external device 230.

The SMF 220 may provide one or more functions, such as session management, UE IP address allocation and management, selection and control of user plane functions, configuration of traffic steering at the UPF 215 to route traffic to a destination, control (e.g., partial control) of policy enforcement or QoS, or downlink data notification. In some aspects, the SMF 220 may communicate with the AMF 210 over an N11 interface 240.

The RAN 225 may include one or more gNBs 255 or one or more ng-eNBs 260. The gNB(s) 255 or the ng-eNB(s) 260 may be examples of the network nodes 105 described with reference to FIG. 1. For instance, a next generation RAN (NG-RAN) may include one or more gNBs 255, or other examples of the RAN 225 may include one or more ng-eNBs 260 or gNBs 255.

The core network 130-a may communicate with the RAN 225 via a C-plane interface 245 (e.g., NG-C or N2 interface) or a U-plane interface 250 (e.g., NG-U or N3 interface). The C-plane interface 245 or the U-plane interface 250 may connect the gNB 255 or the ng-eNB 260 to the core network 130-a (e.g., to one or more control plane functions or one or more user plane functions). For instance, the C-plane interface 245 may connect the AMF 210 to one or more gNBs 255 or ng-eNBs 260 in the RAN 225, or the U-plane interface 250 may connect the UPF 215 to one or more gNBs 255 or ng-eNBs 260 in the RAN 225. The gNB(s) 255 or ng-eNB(s) 260 of the RAN 225 may communicate with each other via one or more backhaul communication links 120-a (e.g., Xn-C interface). The backhaul communication link(s) 120-a may be examples of the backhaul communication links 120 described with reference to FIG. 1. One or more of the gNBs 255 or ng-eNBs 260 may communicate with one or more UEs 115-a over one or more communication links 125-a (e.g., the Uu interface). The communication link(s) 125-a may be examples of the communication links 125 described with reference to FIG. 1.

The LMF 265 may communicate with the core network 130-a to provide location functionality (e.g., to participate in one or more positioning procedures) for the UE(s) 115-a. The LMF 265 may be an example of the location server 185 described with reference to FIG. 1. The LMF 265 may be implemented as one or more devices (e.g., one or more servers, such as physically separate servers, one or more instruction sets on a single server, or instruction sets distributed across multiple physical servers, among other examples). The LMF 265 may support one or more location services for one or more UEs 115-a that may connect to the LMF 265 via the RAN 225, via the core network 130-a, or via another connection (e.g., the Internet). In some examples, the LMF 265 may communicate with a UE 115-a or another device via a C-plane connection (e.g., using one or more interfaces or protocols for signaling control information, or separate from voice or payload data). In some aspects, the LMF 265 may be integrated into a component of the core network 130-a or may be external to the core network 130-a (e.g., on an external device 230, such as an original equipment manufacturer (OEM) server or other server).

In some examples, the SLP 235 may provide location functionality (e.g., may participate in one or more positioning procedures) for the UE(s) 115-a. The SLP 235 may be an example of the location server 185 described with reference to FIG. 1. The SLP 235 may be implemented as one or more devices (e.g., one or more servers, such as physically separate servers, one or more instruction sets on a single server, or instruction sets distributed across multiple physical servers, among other examples). The SLP 235 may support one or more location services for one or more UEs 115-a that may connect to the SLP 235 via the RAN 225, via the core network 130-a, or via another connection (e.g., the Internet). In some examples, the SLP 235 may communicate with a UE 115-a or another device via a U-plane connection (e.g., using one or more interfaces or protocols for signaling voice or payload data, such as a transmission control protocol (TCP) or IP).

In some examples, the external device 230 may communicate with the LMF 265, the SLP 235, the core network 130-a (e.g., via the AMF 210 or the UPF 215), the RAN 225, or the UE 115-a to obtain location information (e.g., a location estimate) for the UE 115-a. The external device 230 may be referred to as a location services (LCS) client or an external client. The external device 230 may be implemented as one or more devices (e.g., one or more servers, such as physically separate servers, one or more instruction sets on a single server, or instruction sets distributed across multiple physical servers, among other examples). The external device 230 may support one or more location services for one or more UEs 115-a that may connect to the external device 230 via the RAN 225, via the core network 130-a, or via another connection (e.g., the Internet).

In some approaches, the functionality of a gNB 255 may be divided between a CU 160-a, one or more DUs 165-a, or one or more RUs 170-a. The CU 160-a may be an example of the CU 160 described with reference to FIG. 1, the one or more DUs 165-a may be examples of the DU 165 described with reference to FIG. 1, or the one or more RUs 170-a may be examples of the RU 170 described with reference to FIG. 1. In some examples, the CU 160-a may provide one or more functions, such as transferring user data, mobility control, radio access network sharing, positioning, session management, or others, except for one or more functions allocated exclusively to the DU(s) 165-a. A DU 165-a may support one or more cells. The DUs 165-a may communicate with the CU 160-a via midhaul communication links 162-a (e.g., via the F1 interface). The midhaul communication links 162-a may be examples of the midhaul communication links 162 described with reference to FIG. 1. The RUs 170-a may perform one or more functions such as power amplification, signal transmission, or signal reception. The RUs 170-a may communicate with the DUs 165-a via fronthaul communication links 168-a (e.g., via the Fx interface). The fronthaul communication links 168-a may be examples of the fronthaul communication links 168 described with reference to FIG. 1. The UE 115-a may communicate with the gNB 255, RU 170-a, or ng-eNB 260 a via communication links 125-a. The communication links 125-a may be examples of the communication links 125 described with reference to FIG. 1. The UE 115-a may communicate with the CU 160-a via the RRC, SDAP, and PDCP layers, with a DU 165-a via the RLC and MAC layers, or with an RU 170-a via the PHY layer.

As described herein, when a wireless device (e.g., UE 115-a, gNB 255, ng-eNB 260, RU 170-a, DU 165-a, or CU 160-a, among other examples) communicates (e.g., outputs, transmits, obtains, or receives) signaling or information with a network entity (e.g., LMF 265, external device 230, SLP 235, AMF 210, SMF 220, UPF 215, gNB 255, ng-eNB 260, CU 160-a, DU 165-a, or RU 170-a, among other examples), the communication (e.g., transmission or reception) may be carried out directly (without one or more intervening devices or entities) or indirectly (with one or more intervening devices or entities). For example, if the UE 115-a transmits signaling or information to the LMF 265, the signaling or information may be communicated via (or independently from) one or more of the gNB 255, ng-eNB 260, RU 170-a, DU 165-a, CU 160-a, AMF 210, SMF 220, UPF 215, SLP 235, or external device 230, among other examples. Additionally, or alternatively, if the LMF 265 transmits signaling or information to the UE 115-a, the signaling or information may be communicated via (or independently from) one or more of the gNB 255, ng-eNB 260, RU 170-a, DU 165-a, CU 160-a, AMF 210, SMF 220, UPF 215, SLP 235, or external device 230, among other examples.

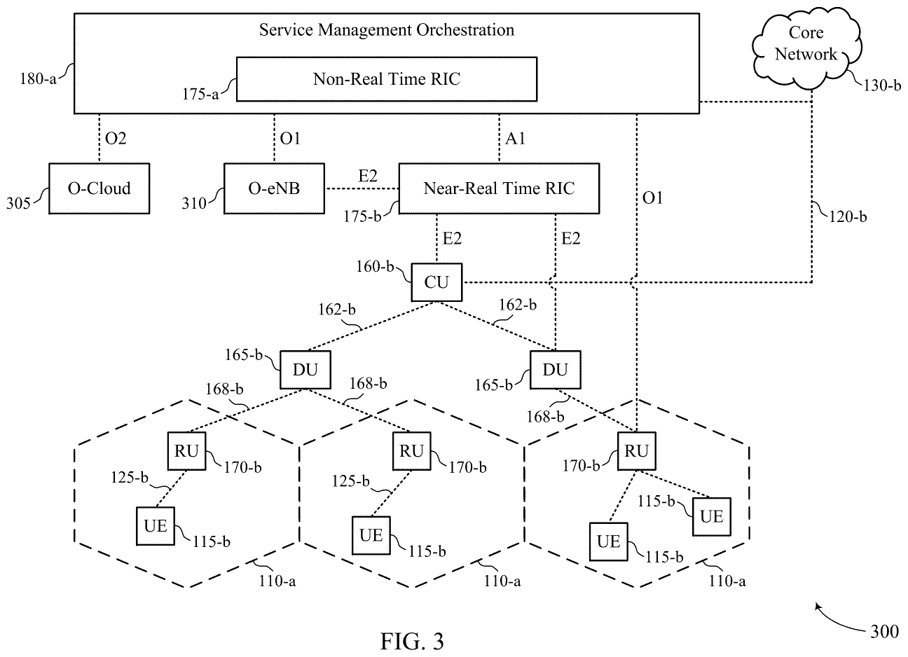

FIG. 3 shows an example of a network architecture 300 (e.g., a disaggregated base station architecture, a disaggregated RAN architecture) that supports PRSs via WUSs in accordance with one or more aspects of the present disclosure. The network architecture 300 may illustrate an example for implementing one or more aspects of the wireless communications system 100. The network architecture 300 may include one or more CUs 160-b that may communicate directly with a core network 130-b via a backhaul communication link 120-b, or indirectly with the core network 130-b through one or more disaggregated network nodes 105 (e.g., a Near-RT RIC 175-b via an E2 link, or a Non-RT RIC 175-a associated with an SMO 180-a (e.g., an SMO Framework), or both). A CU 160-b may communicate with one or more DUs 165-b via respective midhaul communication links 162-b (e.g., an F1 interface). The DUs 165-b may communicate with one or more RUs 170-b via respective fronthaul communication links 168-b. The RUs 170-b may be associated with respective coverage areas 110-a and may communicate with UEs 115-b via one or more communication links 125-b. In some implementations, a UE 115-b may be simultaneously served by multiple RUs 170-b.

Each of the network nodes 105 of the network architecture 300 (e.g., CUs 160-b, DUs 165-b, RUs 170-b, Non-RT RICs 175-a, Near-RT RICs 175-b, SMOs 180-a, Open Clouds (O-Clouds) 305, Open eNBs (O-eNBs) 310) may include one or more interfaces or may be coupled with one or more interfaces configured to receive or transmit signals (e.g., data, information) via a wired or wireless transmission medium. Each network node 105, or an associated processor (e.g., controller) providing instructions to an interface of the network node 105, may be configured to communicate with one or more of the other network nodes 105 via the transmission medium. For example, the network nodes 105 may include a wired interface configured to receive or transmit signals over a wired transmission medium to one or more of the other network nodes 105. Additionally, or alternatively, the network nodes 105 may include a wireless interface, which may include a receiver, a transmitter, or transceiver (e.g., an RF transceiver) configured to receive or transmit signals, or both, over a wireless transmission medium to one or more of the other network nodes 105.

In some examples, a CU 160-b may host one or more higher layer control functions. Such control functions may include RRC, PDCP, SDAP, or the like. Each control function may be implemented with an interface configured to communicate signals with other control functions hosted by the CU 160-b. A CU 160-b may be configured to handle user plane functionality (e.g., CU-UP), control plane functionality (e.g., CU-CP), or a combination thereof. In some examples, a CU 160-b may be logically split into one or more CU-UP units and one or more CU-CP units. A CU-UP unit may communicate bidirectionally with the CU-CP unit via an interface, such as an E1 interface when implemented in an O-RAN configuration. A CU 160-b may be implemented to communicate with a DU 165-b, as necessary, for network control and signaling.

A DU 165-b may correspond to a logical unit that includes one or more functions (e.g., base station functions, RAN functions) to control the operation of one or more RUs 170-b. In some examples, a DU 165-b may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-b may further host one or more low PHY layers. Each layer may be implemented with an interface configured to communicate signals with other layers hosted by the DU 165-b, or with control functions hosted by a CU 160-b.

In some examples, lower-layer functionality may be implemented by one or more RUs 170-b. For example, an RU 170-b, controlled by a DU 165-b, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-b may be implemented to handle over the air (OTA) communication with one or more UEs 115-b. In some implementations, real-time and non-real-time aspects of control and user plane communication with the RU(s) 170-b may be controlled by the corresponding DU 165-b. In some examples, such a configuration may enable a DU 165-b and a CU 160-b to be implemented in a cloud-based RAN architecture, such as a vRAN architecture.

The SMO 180-a may be configured to support RAN deployment and provisioning of non-virtualized and virtualized network nodes 105. For non-virtualized network nodes 105, the SMO 180-a may be configured to support the deployment of dedicated physical resources for RAN coverage requirements which may be managed via an operations and maintenance interface (e.g., an O1 interface). For virtualized network nodes 105, the SMO 180-a may be configured to interact with a cloud computing platform (e.g., an O-Cloud 305) to perform network node life cycle management (e.g., to instantiate virtualized network nodes 105) via a cloud computing platform interface (e.g., an O2 interface). Such virtualized network nodes 105 can include, but are not limited to, CUs 160-b, DUs 165-b, RUs 170-b, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-b via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, artificial intelligence (AI) or machine learning (ML) workflows including model training and updates, or policy-based guidance of applications/features in the Near-RT RIC 175-b. The Non-RT RIC 175-a may be coupled with or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-b, one or more DUs 165-b, or both, as well as an O-eNB 310, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

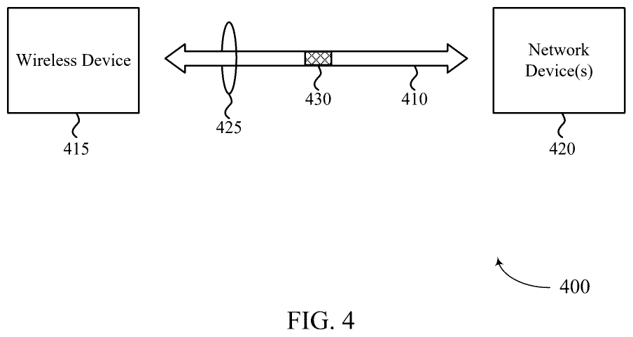

FIG. 4 shows an example of a wireless communications system 400 that supports PRSs via WUSs in accordance with one or more aspects of the present disclosure. The wireless communications system 400 may implement aspects of or may be implemented by aspects of the wireless communications system 100. For example, the wireless communications system 400 includes a wireless device 415, which may be an example of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, or a UE 115-b, RU 170-b, DU 165-b, or CU 160-b described with reference to FIG. 3. The wireless communications system 400 also includes one or more network device(s) 420, one or more of which may be an example of a network node 105, location server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, an RU 170-b, DU 165-b, or CU 160-b described with reference to FIG. 3, a network data analytics function (NWDAF), an over-the-top (OTT) server, an operations, administration, and maintenance (OAM) entity, a server, a core network entity, another entity, or a combination thereof, among other examples. For example, the network device(s) 420 may include one or more network entities, one or more network nodes, or one or more other devices associated with one or more networks. In some cases, some network devices 420 may communicate (e.g., transmit or receive) information or signals with each other, or some network devices 420 may not communicate directly with each other. One or more of the network devices 420 may be included in a same network, in separate networks, in overlapping networks, or in separate networks.

The wireless device 415 may communicate with the network device(s) 420 using one or more links 425, one or more of which may be an example of a communication link 125, a backhaul communication link 120, or a communication link 155 described with reference to FIG. 1, a communication link 125-a, a backhaul communication link 120-a, a C-plane interface 245, or a U-plane interface 250 described with reference to FIG. 2, a communication link 125-b or a backhaul communication link 120-b described with reference to FIG. 3, or another link. The link(s) 425 may include one or more uni-directional or bi-directional links, one or more of which may enable uplink, downlink, or other communications. For example, the wireless device 415 may communicate (e.g., transmit or receive) one or more signals 410, such as control signals or data signals, to or from the network device(s) 420 using the link(s) 425, or the network device(s) 420 may communicate (e.g., transmit or receive) one or more signals 410, such as control signals or data signals, to or from the wireless device 415 using the link 425(s). The signal(s) 410 may include one or more uplink transmissions, downlink transmissions, or other transmissions. One or more of the signal(s) 410 may be communicated via a same link, via separate links, or via different links.

In some approaches, the wireless device 415 or the network device(s) 420 may be capable of performing one or more positioning procedures to generate position or information. A positioning procedure may be one or more operations for estimating a position of an object (e.g., a device such as the wireless device 415 or a UE). As used herein, a “positioning procedure” may include one or more operations for estimating a position of an object.

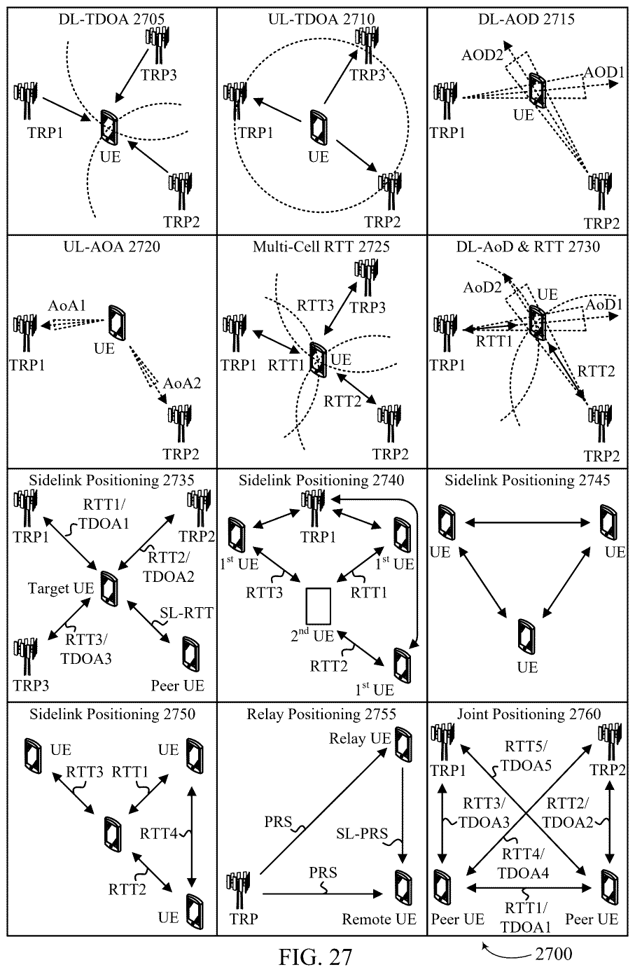

For instance, a positioning procedure may include one or more operations of A-GNSS positioning, OTDOA positioning, E-CID positioning, sensor-based positioning (e.g., monostatic mode(s), bi-static mode(s), or multi-static mode(s)), WLAN-based positioning, Bluetooth-based positioning, TBS positioning, DL-TDOA positioning, DL-AOD positioning, Multi-RTT positioning, NR E-CID positioning, UL-TDOA positioning, or UL-AOA positioning, among other examples. Position information may include an estimated position (e.g., estimated location) or one or more measurements associated with a positioning procedure. For instance, position information may include a position or measurement determined based on one or more positioning procedures, such as A-GNSS positioning, OTDOA positioning, E-CID positioning, sensor-based positioning (e.g., monostatic mode(s), bi-static mode(s), or multi-static mode(s)), WLAN-based positioning, Bluetooth-based positioning, TBS positioning, DL-TDOA positioning, DL-AOD positioning, Multi-RTT positioning, NR E-CID positioning, UL-TDOA positioning, or UL-A positioning, among other examples. Examples of positioning procedures are described with reference to FIG. 27.

A position may be information or data indicating a point, area, or region where an object (e.g., the wireless device 415) is located. A location may be expressed as coordinates (e.g., latitude, longitude, or altitude of a geographic coordinate system (GCS), universal transverse mercator (UTM) coordinates, state plane coordinate system (SPCS) coordinates, or Earth-centered Earth-fixed (ECEF) coordinates, among other examples), an address, or a location relative to another location (e.g., a displacement or distance), among other examples.

A measurement may be measured, sensed, generated, calculated, inferred, or predicted based on one or more samples, sensor data, information, or characteristics of a reference signal. Examples of measurements may include signal strength, reference signal received power (RSRP), reference signal received path power (RSRPP), received signal strength indicator (RSSI), reference signal received quality (RSRQ), signal-to-interference plus noise ratio (SINR), SNR, channel frequency response (CFR), channel impulse response (CIR), power delay profile (PDP), delay profile (DP), channel quality indicator (CQI), CSI, line-of-sight (LOS) indicator, time of arrival (TOA), angle of arrival (AOA), angle of departure (AOD), round-trip time (RTT), reference signal time difference (RSTD), time difference of arrival (TDOA), reference signal carrier phase (RSCP), reference signal carrier phase difference (RSCPD), reception-to-transmission (Rx-Tx) time difference, range, distance, image data, temperature data, or motion data, among other examples. In some examples, a measurement may be data or an indicator that indicates one or more of the aforementioned values.

In some examples, a network node may output (e.g., transmit), or the wireless device 415 may obtain (e.g., receive), a reference signal. Additionally, or alternatively, the wireless device 415 may output (e.g., transmit), or a network node may obtain (e.g., receive) a reference signal. The reference signal may be a signal (e.g., electromagnetic signal, RF signal) with one or more established characteristics (e.g., signaling pattern, strength, amplitude, magnitude, frequency, timing, modulation, phase, or data, among other examples). For instance, the wireless device 415 or a network node may store information indicating one or more of the characteristics of the reference signal, which may allow for comparison of one or more stored characteristics and one or more characteristics of the received reference signal. The reference signal (e.g., the comparison) may enable channel estimation (e.g., channel attenuation, phase, frequency shift, or Doppler effects, among other examples), positioning, or tracking. Examples of the reference signal may include a reference signal of a synchronization signal block (SSB), a CSI-RS, a PRS, an SRS, a demodulation reference signal (DMRS), or a tracking reference signal (TRS), among other examples.

In some examples, the wireless device 415 may include one or more radios (e.g., one or more transceivers or signal processing circuitry). For instance, the wireless device 415 may include a first radio, a second radio, and one or more antennas. The first radio may be implemented in hardware (e.g., circuitry) or a combination of hardware and instructions (e.g., a processor with instructions). The second radio may be implemented in hardware (e.g., circuitry) or a combination of hardware and instructions (e.g., a processor with instructions). In some examples, the first radio (e.g., a WUR or LP-WUR) may have reduced complexity, reduced capability, or reduced power consumption relative to the second radio. For instance, the first radio may perform envelope detection, sequence detection, OOK modulation/demodulation, or signal measurement. The second radio may be capable of performing one or more functions (e.g., QAM modulation/demodulation, OFDM processing, or baseband processing, among other examples) that the first radio may not perform (or may not be capable of performing, for instance). Additionally, or alternatively, the first radio may consume less operating power than an operating power of the second radio. For instance, when the second radio is in an awake state (e.g., active state, operating state, or full power state), the second radio may consume more power than the first radio in operation.

In some examples, the first radio may be an LP-WUR. For instance, the first radio may monitor signals received via the antenna(s) to provide a WUS to the second radio. In some aspects, the first radio may operate when the second radio is in a sleep state (e.g., a low-power, idle, or inactive state), and may function to provide the WUS to the second radio to wake or activate the second radio. Additionally, or alternatively, the first radio may operate when the second radio is in an awake state. In some approaches, the first radio and the second radio may be integrated into a single radio. Additionally, or alternatively, the first radio may operate independently, or may provide one or more signals to the second radio for processing (e.g., additional processing).

The network device(s) 420 (e.g., a network node, gNB, or base station) may output (e.g., transmit), or the wireless device 415 may obtain (e.g., receive) a WUS 430 that includes an OOK symbol. The OOK symbol may include at least a portion of a PRS. For example, the at least a portion of the PRS may be overlaid on, combined with, or carried via the OOK symbol. For instance, at least one of the network device(s) 420 may output a joint transmission of an OFDM-based PRS and an OOK LP-WUS. The OOK LP-WUS may include a (e.g., may utilize a) waveform envelope to carry WUS information (e.g., one or more symbols relating to a WUS). In some examples, an OOK symbol including at least a portion of a PRS may denote that the at least a portion of a PRS is on the OOK symbol, is overlaid with the OOK symbol, is combined with the OOK symbol, is carried via the OOK symbol, or is included in an OOK symbol. An “overlaid” sequence (e.g., at least a portion of a PRS) or at least a portion of a PRS being included in an OOK symbol may refer to content of one or more “on” symbols being at least a part of the sequence. For instance, the content of one or more “on” symbols may be at least part of a PRS (or other signal or content). In some approaches, the term “overlaid” may not indicate having two concurrent signals (e.g., two separate signals) at the same time or frequency resource. In some examples, an “on” symbol in the context of LP-WUS may mean that a non-zero approximately constant envelope may occur during a period. One or more approaches may be utilized to fill the period to ensure the approximately constant envelope. Some examples of the techniques described herein may fill the content of the period (of an “on” symbol, for instance).

The wireless device 415 may determine a position measurement(s) based on the at least a portion of the PRS. For example, the wireless device 415 may generate information based on a position measurement of the at least a portion of the PRS (included in the OOK symbol in some examples). For instance, the information (e.g., position information or location information) may be one or more measurements (e.g., the position measurement(s) or one or more other measurements based on the position measurement(s)), an indication of one or more measurements (e.g., an indication of the position measurement(s) or of one or more other measurements based on the position measurement(s), such as a code, data, or an index, among other examples), or an indication of a position (e.g., position estimate) that is based on the position measurement(s), among other examples. In some approaches, the wireless device 415 may measure or process the PRS via the first radio, the second radio, or a combination thereof. In some examples, the wireless device 415 may participate in a positioning procedure. Participating in the positioning procedure may include determining the position measurement or generating information based on a position measurement. A position measurement may be a measurement that relates to a position of an object (e.g., a position of the wireless device 415), a measurement that is based on a signal (e.g., PRS), or a measurement that may be utilized (at least in part) to determine a position of an object (e.g., the wireless device 415).

The wireless device 415 may output (e.g., transmit), or the network device(s) 420 (e.g., a network node, a network entity, or a combination thereof, among other examples) may obtain (e.g., receive), the information that is based on the position measurement of the at least a portion of the PRS. In some examples, the information may be an indication of the measurement(s) of the PRS. Additionally, or alternatively, the information may be an indication of a position of the wireless device 415. For instance, the wireless device 415 may participate in the positioning procedure by determining an estimate of a position of the wireless device 415 based on the measurement(s) of the PRS or transmitting an estimate of the position of the wireless device 415 based on the measurement(s). In some approaches, the wireless device 415 may output (e.g., transmit), or the network device(s) 420 may obtain (e.g., receive), information related to a positioning procedure (e.g., information that is based on the position measurement of the at least a portion of the PRS).

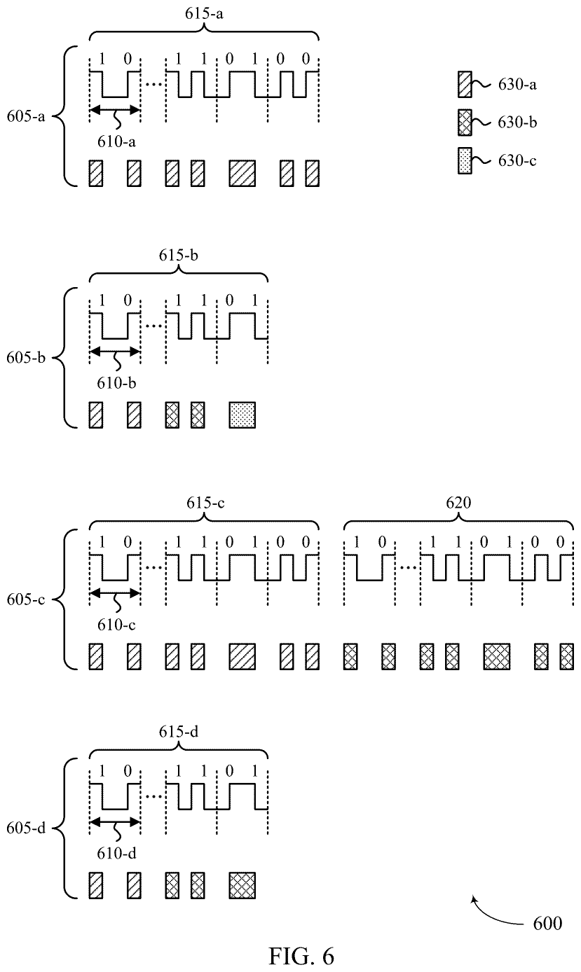

In some approaches, the at least a portion of the PRS may be carried on one or more OOK symbols with an on state in a duration of an OFDM symbol. Within an OOK symbol (e.g., “on” symbol), for instance, the entire or partial PRS may be transmitted depending on the OOK symbol duration. As used herein, M may denote a quantity of OOK symbols in a duration of an OFDM symbol. For instance, an OFDM symbol duration may be utilized as a basic time unit to help ensure a time alignment between an LP-WUS and one or more other signals (e.g., legacy signal(s)) that may be frequency division multiplexed with the LP-WUS. In some approaches, the design of the WUS may be general enough for an OFDM symbol duration or another duration to be utilized as a reference time unit. An example where M=4 on or off symbols are transmitted in each OFDM symbol duration is given with reference to FIG. 6.

In some aspects, the OOK symbol may have a same duration as an OFDM symbol, and the at least a portion of the PRS may be modulated in the frequency domain on one or more subcarriers for the WUS 430. When M=1 (e.g., the on/off symbol duration is identical to an OFDM symbol duration), for instance, the overlaid PRS may be modulated (e.g., directly modulated) in the frequency domain over one or more allocated LP-WUS subcarriers.

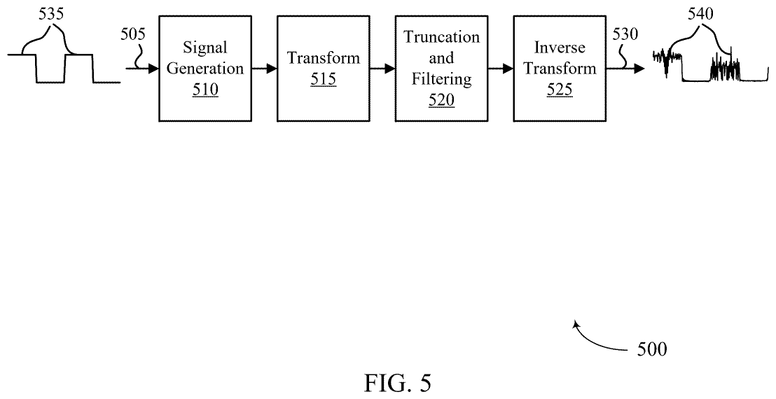

In some examples, the OOK symbol may have a shorter duration than an OFDM symbol, and the at least a portion of the PRS may be a time domain signal (or a signal generated in the time domain). When M>1, for instance, the on/off symbol duration may be smaller than the OFDM symbol duration. To maintain the OOK pattern and bandwidth of the LP-WUS, the overlaid PRS may be a time domain signal (or a signal generated in the time domain) or a mixed numerology approach may be utilized. An example where the overlaid PRS is a time domain signal (or a signal generated in the time domain) for a single carrier frequency domain modulated (SC-FDM) waveform is provided with reference to FIG. 5.

In some aspects, the OOK symbol may have a shorter duration than an OFDM symbol, and the at least a portion of the PRS may be modulated in the frequency domain with a subcarrier spacing (SCS). For instance, a mixed numerology-based approach may be utilized, where the overlaid PRS may be modulated in the frequency domain with a relatively large SCS. For example, if the OFDM symbol duration is 1/B_{scs}, the SCS for the overlaid PRS may be M*B_{SCS}. In some approaches, the at least a portion of the PRS is modulated in the frequency domain with a first SCS that is a quantity (e.g., M, an integer, or another quantity) times a second SCS of the OFDM symbol.

Some examples of the techniques described herein may relate to overlaid

PRS, which may allow for communication and positioning (instead of dedicated PRS, for instance). For example, an OOK LP-WUS may carry WUS information, where an entire or partial PRS may be included within an OOK symbol. In some examples, PRS multiplexing may be performed for one or more overlaid PRSs. Since the duration of an LP-WUS may be relatively long, time division multiplexing (TDM)-based PRS multiplexing may be utilized. For instance, multiple PRSs may be time-division multiplexed in the WUS 430 or across multiple WUSs. In some approaches, TDM-based PRS multiplexing may be performed within an LP-WUS. In some approaches, TDM-based PRS multiplexing may be performed across (e.g., on) LP-WUS repetitions. PRS repetitions may be performed at an OOK symbol level, slot level, or LP-WUS repetition level. A capability exchange may be performed for one or more of the functionalities described herein.

In some aspects, different PRSs may have different quantities of OOK symbols (e.g., “on” symbols) to compensate for different path loss from different cells. In some examples, a first PRS of the multiple PRSs may correspond to a first cell and a second PRS of the multiple PRSs may correspond to a second cell, where the first PRS may be communicated via a first quantity of OOK symbols and the second PRS may be communicated via a second quantity of OOK symbols that is different from the first quantity of symbols. Examples of TDM-based PRS multiplexing in a WUS are given with reference to FIG. 6.

In some approaches, the at least a portion of the PRS may span a single OOK symbol, multiple OOK symbols, or all OOK symbols (with an “on” state, for example) of the WUS 430. For instance, one or more overlaid PRSs may span a part of the OOK “on” symbols of the LP-WUS or may span all of the OOK “on” symbols of the LP-WUS.

In some aspects, at least a portion of the PRS may be frequency-division multiplexed on the WUS 430 in accordance with a comb. For example, comb-based FDM may be supported to increase spectrum efficiency or lower positioning latency. In some approaches, if TDM-based PRS multiplexing is performed without FDM, the overlaid PRS may be with a “comb 1.”

In some examples, a resource for communication of PRS signaling may repeat based on a quantity of OOK symbols, a quantity of OFDM symbols, a quantity of slots, or a quantity of WUS repetitions. For instance, overlaid PRS resource repetition could be performed in accordance with one or more approaches. In a first approach, PRS resource repetition may be performed (e.g., transmitted or received) with an OOK symbol level granularity. For example, a “PRS-ResourceTimeGap” may indicate an offset in units of OOK symbols between two repeated instances of a downlink PRS resource (e.g., DL PRS Resource) corresponding to a same PRS resource identifier (e.g., PRS Resource ID) in a single instance of a downlink PRS resource set (e.g., DL PRS Resource Set).

In a second approach, PRS resource repetition may be performed (e.g., transmitted or received) with an OFDM symbol level granularity. For example, a PRS-ResourceTimeGap” may indicate an offset in units of OFDM symbols between two repeated instances of a downlink PRS resource (e.g., DL PRS Resource) corresponding to a same PRS resource identifier (e.g., PRS Resource ID) within a single instance of a downlink PRS resource set (e.g., DL PRS Resource Set).

In a third approach, PRS resource repetition may be performed (e.g., transmitted or received) with a slot level granularity. For example, a “PRS-ResourceTimeGap” may indicate an offset in units of slots between two repeated instances of a downlink PRS resource (e.g., DL PRS Resource) corresponding to a same PRS resource identifier (e.g., PRS Resource ID) within a single instance of a downlink PRS resource set (e.g., DL PRS Resource Set).

In a fourth approach, PRS resource repetition may be performed (e.g., transmitted or received) with an LP-WUS repetition level granularity. For example, a “PRS-ResourceTimeGap” may indicate an offset in units of LP-WUS repetition between two repeated instances of a downlink PRS resource (e.g., DL PRS Resource) corresponding to a same PRS resource identifier (e.g., PRS Resource ID) within a single instance of a downlink PRS resource set (e.g., DL PRS Resource Set).

In some examples, the wireless device 415 may output (e.g., transmit), or a network device(s) 420 (e.g., network node or network entity) may obtain (e.g., receive), capability information indicating a capability of the wireless device 415 to receive the WUS 430 that includes the OOK symbol (that includes the at least a portion of the PRS). Additionally, or alternatively, a network device(s) 420 (e.g., network node or network entity) may output, or the wireless device 415 may obtain (e.g., receive), configuration information indicating that the wireless device 415 is to receive the WUS 430 that includes the OOK symbol (that includes the at least a portion of the PRS).

In some approaches, two or more network devices 420 may perform signaling to manage or control PRS or WUS signaling. For wireless device 415 (e.g., UE) positioning, a network entity (e.g., location server) may coordinate the transmission of the overlaid PRS across different cells. As described herein, an LP-WUS may serve a purpose of waking up one or wireless devices (e.g., UEs) within a serving cell. Accordingly, signaling between a network node (e.g., base station or gNB, among other examples) and a network entity (e.g., location server) may be performed for controlling or managing a PRS overlaid on the WUS 430.

In some examples, capability exchange signaling may be performed between one or more network nodes (e.g., base station(s)) of the network device(s) 420 and one or more network entities (e.g., location server(s)) of the network device(s) 420. For example, a network node may output (e.g., transmit), or a network entity may obtain (e.g., receive), capability information indicating that the network node is capable of transmitting the at least a portion of the PRS (included in the OOK symbol of the WUS 430, in some examples). For instance, the capability information may indicate whether the network node (e.g., base station) supports transmission of overlaid PRS. If the capability information indicates that the network node does not support transmission of overlaid PRS, one or more of the other capabilities described herein may not be signaled in some approaches. The network entity may output (e.g., transmit), or the network node may obtain (e.g., receive), configuration information indicating that the network node is to transmit the at least a portion of the PRS included in the OOK symbol of a WUS 430. The configuration information may be based on (e.g., in accordance with) the capability information.

In some examples, the network node may output (e.g., transmit), or the network entity may obtain (e.g., receive), an indication of a periodicity of PRS signaling on WUS signaling that the network node is capable of transmitting, an indication of a type of PRS signaling on WUS signaling that the network node is capable of transmitting, a bandwidth of PRS signaling on WUS signaling that the network node supports, a duration of WUS signaling via which PRS signaling is supported by the network node, an indication of one or more activity modes the network node supports for PRS signaling on WUS signaling, or an indication of whether PRS signaling on WUS signaling during a connected mode discontinuous reception (CDRX) is supported by the network node, or any combination thereof. For instance, the capability information may indicate a supported periodicity for overlaid PRS, a type of overlaid PRS supported by the network node (e.g., base station), such as the “M” value of the LP-WUS to transmit overlaid PRS. Additionally, or alternatively, the capability information may indicate a quantity (e.g., maximum quantity) of supported bandwidth for overlaid PRS, a duration of an LP-WUS that may be utilized to transmit overlaid PRS, whether the overlaid PRS could be transmitted inside the CDRX “on” duration, or whether the overlaid PRS may be configured in an idle mode, inactive mode, or active mode.

In some aspects, the network entity may output (e.g., transmit), or the network node may obtain (e.g., receive), a request for an indication of a pattern of the WUS 430 corresponding to a wireless device 415. For instance, the network entity (e.g., location server) may, on-demand, request a network node (e.g., serving base station) to indicate a time or frequency pattern of the OOK signal for a wireless device 415 (e.g., for a specific UE). The pattern of the WUS 430 may be information for the network entity (e.g., location server) to coordinate the overlaid PRS transmission across different cells. The network node may output (e.g., transmit), or the network entity may obtain (e.g., receive) the indication of the pattern of the WUS 430 corresponding to the wireless device 415 based on the request.

In some approaches, a network entity may output (e.g., transmit), or the network entity may obtain (e.g., receive), a request that the network node transmit the at least a portion of the PRS (included in the OOK symbol, for instance) in accordance with a pattern. Communicating (e.g., outputting, transmitting, obtaining, or receiving) the WUS 430 that includes the OOK symbol may be based on the pattern. For instance, the network entity (e.g., location server) may, on-demand, request that one or more network nodes (e.g., gNB(s)) transmit a PRS with time or frequency pattern of the OOK signal. In some cases, the network node(s) (e.g., gNB(s)) may not have information indicating which wireless device (e.g., UE) is receiving the PRS.

In some examples, the wireless device may output (e.g., transmit), or a network device 420 (e.g., network node or network entity) may obtain (e.g., receive), a request for the WUS 430 that includes the OOK symbol (that includes the at least a portion of the PRS). For instance, the wireless device 415 (e.g., UE) may, on-demand, request overlaid PRS during one or more periods or time instances. The WUS 430 may be communicated (e.g., output, transmitted, obtained, or received) based on the request. For instance, the network entity may command or request that the network node output the WUS 430 in response to the request.

In some examples of the techniques described herein, one or more signals, indications, or information (e.g., request(s), configuration information, or capability information, among other examples) described herein may be communicated (e.g., transmitted or received) as part of a protocol or signaling procedure. For instance, the wireless device 415 (e.g., UE) or the network device(s) 420 (e.g., network node(s), LMF, or other network entity(ies)) may communicate in accordance with an LTE positioning protocol (LPP), in accordance with an NR positioning protocol A (NRPPA), via LPP signaling, or via NRPPA signaling.

In some approaches, the wireless device 415 or the network device(s) 420 may participate in a capability exchange that may include one or more signals or messages communicated between the wireless device 415 and the network device(s) 420, or among network devices 420. The capability exchange may be based on, or may be performed in accordance with, a protocol (e.g., LPP, NRPPA, via LPP signaling, or via NRPPA signaling, among other examples). In some aspects, a capability exchange may include request signaling (e.g., a request for capability information, a request message(s) indicating a request for a WUS that includes an OOK, a request for an indication of a pattern of a WUS corresponding to a wireless device 415, or a request that a network node transmit the at least a portion of a PRS included in an OOK symbol in accordance with a pattern, among other examples) or capability information signaling (e.g., message(s) indicating capability information or one or more capabilities of the wireless device 415 or of a network device(s) 420). In some approaches, the capability information may be communicated based on a request (e.g., in response to a request from the network device(s) 420), independent of a request, or without a request.

Some examples of capability information that may be communicated (e.g., in accordance with LPP, NRPPA, via LPP signaling, or via NRPPA signaling, among other examples) may include capability information indicating a capability of the wireless device 415 to receive a WUS that includes an OOK symbol that includes at least a portion of a PRS, capability information indicating that a network node is capable of transmitting at least a portion of a PRS included in an OOK symbol of a WUS, or capability information including an indication of a periodicity of PRS signaling on WUS signaling that a network node is capable of transmitting, an indication of a type of PRS signaling on WUS signaling that a network node is capable of transmitting, a bandwidth of PRS signaling on WUS signaling that a network node supports, a duration of WUS signaling via which PRS signaling is supported by a network node, an indication of one or more activity modes a network node supports for PRS signaling on WUS signaling, or an indication of whether PRS signaling on WUS signaling during a CDRX (e.g., CDRX mode) is supported by a network node, or any combination thereof, among other examples.

In some approaches, one or more network devices 420 may communicate or store capability information associated with the wireless device 415 (or one or more other wireless devices) or a network device(s) 420 (e.g., network node(s), TRP(s), or RU(s), among other examples). For instance, the wireless device 415 may output (e.g., transmit) capability information to an LMF. The LMF may store the capability information or may communicate the capability information to an AMF (or other entity) for storage. A network device(s) 420 (e.g., LMF, AMF, other network device(s), or a combination thereof) may access the stored capability information associated with the wireless device 415, which may reduce repeated capability exchanges or signaling of the capability information between the wireless device 415 and the network device(s) 420. For instance, a network device(s) 420 may store or access one or more kinds of capability information described herein associated with the wireless device 415 or a network device(s) 420.

In some approaches, the network device(s) 420 or the wireless device 415 may communicate (e.g., transmit or receive) configuration information. The communication of configuration information may be based on, or may be performed in accordance with, a protocol (e.g., LPP, NRPPA, via LPP signaling, or via NRPPA signaling, among other examples). In some aspects, communicating the configuration information may be performed as part of a capability exchange or separate from a capability exchange. In some approaches, configuration information may be communicated based on request signaling (e.g., a request message(s) indicating a request from the wireless device 415 for configuration information of the network device(s) 420, or a request message(s) indicating a request from one network device 420 to another network device 420 for configuration information). The configuration information may be communicated based on a request (e.g., in response to a request from the wireless device 415), independent of a request, or without a request.

Some examples of configuration information that may be communicated (e.g., in accordance with LPP, NRPPA, via LPP signaling, or via NRPPA signaling, among other examples) may include configuration information indicating that the wireless device 415 is to receive a WUS that includes an OOK symbol that includes at least a portion of a PRS, or configuration information indicating that a network node is to transmit at least a portion of a PRS included in an OOK symbol of a WUS, among other examples.

In some approaches, one or more wireless devices 415 or network device(s) 420 may determine or communicate configuration information based on (e.g., in accordance with) the capability information. For instance, a network device(s) (e.g., LMF) may configure the wireless device 415 to perform one or more operations accordance with one or more of the capabilities of the wireless device 415.

FIG. 5 shows an example of a block diagram 500 that supports PRSs via WUSs in accordance with one or more aspects of the present disclosure. In FIG. 5, the blocks may represent one or more functions or operations performed by a device (e.g., a network node or wireless device, among other examples), or one or more components or elements included in a device to generate a WUS with overlaid PRS 530. One or more of the components or elements may be implemented in hardware (e.g., circuitry) or a combination of hardware and instructions (e.g., a processor with instructions). In some examples, one or more of the operations may be performed by one or more network devices 420 (e.g., network node(s)) or wireless devices 415 described with reference to FIG. 4. Additionally, or alternatively, one or more of the components may be included in one or more network devices 420 (e.g., network node(s)) or wireless devices 415 described with reference to FIG. 4.

The example of FIG. 5 illustrates an approach to generate the WUS with overlaid PRS 530 in accordance with an SC-FDM waveform. In the example of FIG. 5, a WUS 505 may include two OOK “on” symbols 535, where M=4 (e.g., 4 OOK symbols per OFDM symbol). The WUS 505 may be provided to a signal generation component 510, which may generate an overlaid PRS. The signal generation component 510 may output a time domain signal (or a signal generated in the time domain) to a transform component 515.

The transform component may perform a discrete Fourier transform (DFT) or least squares operation on the WUS 505, which may be provided to a truncation and filtering component 520. The truncation and filtering component may filter the WUS 505 or truncate a portion of the WUS 505 to produce a frequency-domain signal. The frequency-domain signal may be provided to an inverse transform component 525.

The inverse transform component 525 may perform an IFFT or add a cyclic prefix (CP) based on the frequency-domain signal. The inverse transform component 525 may operate based on one or more subcarriers (e.g., LP-WUS subcarriers) or one or more other signals (e.g., legacy signals). For instance, the inverse transform component 525 may transform the frequency-domain signal into the time domain with an added CP to produce the WUS with overlaid PRS 530. As illustrated in FIG. 5, the WUS with overlaid PRS 530 may include a PRS 540 overlaid on the “on” OOK symbols of the WUS 505. It should be noted that for M=1, an overlaid PRS may additionally, or alternatively, be generated in an SC-FDM waveform.

FIG. 6 shows examples of timing diagrams 600 that support PRSs via WUSs in accordance with one or more aspects of the present disclosure. For instance, FIG. 6 illustrates examples of a first scenario 605-a, a second scenario 605-b, a third scenario 605-c, and a fourth scenario 605-d in accordance with some of the techniques described herein. In the examples of FIG. 4, M=4 OOK symbols (e.g., 4 on or off symbols) are transmitted in each OFDM symbol duration. The examples illustrate times at which a first PRS 630-a (e.g., PRS 1), a second PRS 630-b (e.g., PRS k or PRS 2), or a third PRS 630-c (e.g., PRS k+1) are overlaid on one or more WUSs in the first scenario 605-a, the second scenario 605-b, the third scenario 605-c, and the fourth scenario 605-d. The examples of the scenarios may be independent. In the examples, an “on” OOK symbol (e.g., a symbol with a higher signal value or voltage) that transitions to an “off” OOK symbol (e.g., a symbol with a lower signal value or voltage) may correspond to a value of “1” of a WUS, or an “off” OOK symbol that transitions to an “on” OOK symbol may correspond to a value of “0” of a WUS.

In example of the first scenario 605-a, the M=4 OOK symbols occupy a first OFDM symbol duration 610-a. A first PRS 630-a (e.g., a low-power PRS (LP-PRS)) is overlaid on the “on” OOK symbols of a WUS 615-a (e.g., one LP-WUS) in the first scenario 605-a.

An example of TDM-based PRS multiplexing within a second WUS 615-b (e.g., a single LP-WUS) is illustrated. In the example of the second scenario 605-b, the M=4 OOK symbols occupy a second OFDM symbol duration 610-b. A first PRS 630-a (e.g., PRS 1) is overlaid on the “on” OOK symbols of a first portion of the second WUS 615-b, a second PRS 630-b (e.g., PRS k) is overlaid on the “on” OOK symbols of a second portion of the second WUS 615-b, and a third PRS 630-c (e.g., PRS k+1) is overlaid on the “on” OOK symbols of a third portion of the second WUS 615-b.

An example of TDM-based PRS multiplexing across WUS repetitions (e.g., LP-WUS repetitions) is illustrated. In the example of the third scenario 605-c, the M=4 OOK symbols occupy a third OFDM symbol duration 610-c. A first PRS 630-a (e.g., PRS 1) is overlaid on the “on” OOK symbols of a third WUS 615-c (e.g., an initial WUS or “repetition”), and a second PRS 630-b (e.g., PRS 2) is overlaid on the “on” OOK symbols of a WUS repetition 620 (e.g., a second repetition of the third WUS 615-c).

An example of TDM-based PRS multiplexing within a fourth WUS 615-d (e.g., an LP-WUS) is illustrated. In the example of the fourth scenario 605-d, the M=4 OOK symbols occupy a fourth OFDM symbol duration 610-d. A first PRS 630-a (e.g., PRS 1) is overlaid on the “on” OOK symbols of a first portion of the fourth WUS 615-d, and a second PRS 630-b (e.g., PRS 2) is overlaid on the “on” OOK symbols of a second portion of the fourth WUS 615-d, where the first PRS 630-a spans a different quantity of OOK symbols than the second PRS 630-b.

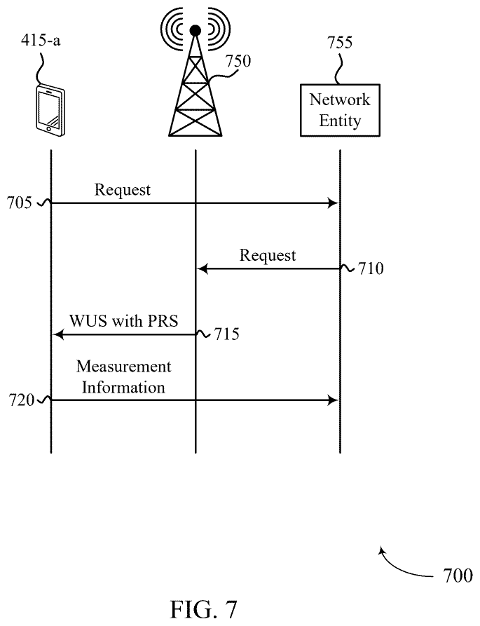

FIG. 7 shows an example of a process flow 700 that supports PRSs via WUSs in accordance with one or more aspects of the present disclosure. The process flow 700 may include a wireless device 415-a, which may be an example of a UE 115, UE 115-a, UE 115-b, or a wireless device 415, as described herein. The process flow 700 may also include a network node 750, which may be an example of a network node 105, UE 115, UE 115-a, gNB 255, ng-eNB 260, CU 160, CU 160-a, CU 160-b, DU 165, DU 165-a, DU 165-b, RU 170, RU 170-a, RU 170-b, UE 115-b, network device 420, TRP, or RRH, as described herein. The process flow 700 may additionally include an network entity 755, which may be an example of the network node 105, gNB 255, ng-eNB 260, CU 160, CU 160-a, CU 160-b, DU 165, DU 165-a, DU 165-b, RU 170, RU 170-a, RU 170-b, location server 185, AMF 210, SMF 220, UPF 215, LMF 265, external device 230, or SLP 235, as described herein.

In the following description of the process flow 700, the communications between the wireless device 415-a, the network node 750, or the network entity 755 may be transmitted in the example order shown or in a different order than the example order shown. Additionally, or alternatively, the operations performed by the wireless device 415-a, the network node 750, or the network entity 755 may be performed in different orders or at different times. One or more operations may be omitted from the process flow 700, or one or more other operations may be added to the process flow 700. Although some operations or signaling may be shown to occur at different times for discussion purposes, these operations may actually occur at separate (e.g., non-overlapping) times, at the same time, in overlapping time periods in some examples.

In some examples, the wireless device 415-a or the network entity 755 may communicate information via the network node 750 (e.g., via a network node, base station, or gNB, among other examples). Additionally, or alternatively, the wireless device 415-a or the network entity 755 may communicate information independent of the network node 750. In some examples, the wireless device 415-a or the network entity 755 may communicate information, where the information may be relayed transparently via the network node 750, the information may be processed by the network node 750 before communication to the wireless device 415-a or the network entity 755, or the information may not be transmitted to the wireless device 415-a or the network entity 755.

At 705, the network entity 755 may output (e.g., transmit), or the wireless device 415-a may obtain (e.g., receive), a request for a WUS that includes at least one OOK symbol that includes at least a portion of a PRS. For instance, the request may be communicated as described with reference to FIG. 4.

At 710, the network entity 755 may output (e.g., transmit), or the network node 750 may obtain (e.g., receive), a request that the network node 750 transmit the at least the portion of the PRS on the at least one OOK symbol of the WUS. In some examples, the request may be communicated as described with reference to FIG. 4.

At 715, the network node 750 may output (e.g., transmit), or the wireless device 415-a may obtain (e.g., receive), the WUS that includes at least one OOK symbol that includes at least a portion of the PRS. In some examples, the WUS may be communicated as described with reference to FIG. 4.

At 720, the wireless device 415-a may output (e.g., transmit), or the network entity 755 may obtain (e.g., receive), measurement information (e.g., information that is based on a position measurement). In some examples, the measurement information may be communicated as described with reference to FIG. 4. For instance, the wireless device 415-a may transmit the measurement information of the at least a portion of the PRS measured from the WUS.

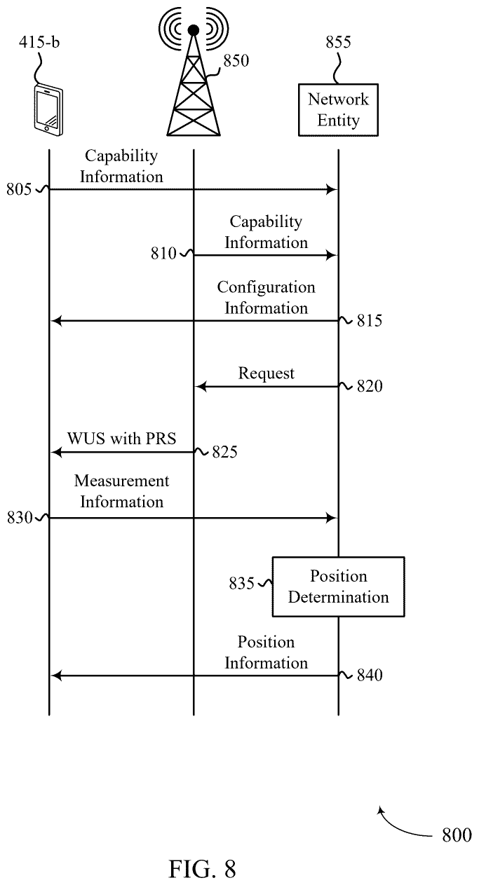

FIG. 8 shows an example of a process flow 800 that supports PRSs via WUSs in accordance with one or more aspects of the present disclosure. The process flow 800 may include a wireless device 415-b, which may be an example of a UE 115, UE 115-a, UE 115-b, or a wireless device 415, as described herein. The process flow 800 may also include a network node 850, which may be an example of a network node 105, UE 115, UE 115-a, gNB 255, ng-eNB 260, CU 160, CU 160-a, CU 160-b, DU 165, DU 165-a, DU 165-b, RU 170, RU 170-a, RU 170-b, UE 115-b, network device 420, TRP, or RRH, as described herein. The process flow 800 may additionally include an network entity 855, which may be an example of the network node 105, gNB 255, ng-eNB 260, CU 160, CU 160-a, CU 160-b, DU 165, DU 165-a, DU 165-b, RU 170, RU 170-a, RU 170-b, location server 185, AMF 210, SMF 220, UPF 215, LMF 265, external device 230, or SLP 235, as described herein.

In the following description of the process flow 800, the communications between the wireless device 415-b, the network node 850, or the network entity 855 may be transmitted in the example order shown or in a different order than the example order shown. Additionally, or alternatively, the operations performed by the wireless device 415-b, the network node 850, or the network entity 855 may be performed in different orders or at different times. One or more operations may be omitted from the process flow 800, or one or more other operations may be added to the process flow 800. Although some operations or signaling may be shown to occur at different times for discussion purposes, these operations may actually occur at separate (e.g., non-overlapping) times, at the same time, in overlapping time periods in some examples.

In some examples, the wireless device 415-b or the network entity 855 may communicate information via the network node 850 (e.g., via a network node, base station, or gNB, among other examples). Additionally, or alternatively, the wireless device 415-b or the network entity 855 may communicate information independent of the network node 850. In some examples, the wireless device 415-b or the network entity 855 may communicate information, where the information may be relayed transparently via the network node 850, the information may be processed by the network node 850 before communication to the wireless device 415-b or the network entity 855, or the information may not be transmitted to the wireless device 415-b or the network entity 855.

At 805, the wireless device 415-b may output (e.g., transmit), or the network entity 855 may obtain (e.g., receive), capability information indicating a capability of the wireless device 415-b to receive a WUS that includes an OOK symbol that comprises at least a portion of the PRS. In some examples, the capability information may be communicated as described with reference to FIG. 4.

At 810, the network node 850 may output (e.g., transmit), or the network entity 855 may obtain (e.g., receive), capability information indicating that the network node 850 is capable of transmitting at least a portion of a PRS included in an OOK symbol of a WUS. In some examples, the capability information may be communicated as described with reference to FIG. 4.

At 815, the network entity 855 may output (e.g., transmit), or the wireless device 415-b may obtain (e.g., receive), configuration information indicating that the wireless device is to receive the WUS that includes the OOK symbol that comprises the at least a portion of the PRS. In some examples, the configuration information may be communicated as described with reference to FIG. 4.

At 820, the network entity 855 may output (e.g., transmit), or the network node 850 may obtain (e.g., receive), a request that the network node 850 transmit the at least a portion of the PRS (included in the OOK symbol, for instance). In some examples, the request may be communicated as described with reference to FIG. 4.

At 825, the network node 850 may output (e.g., transmit), or the wireless device 415-b may obtain (e.g., receive), the WUS that includes at least one OOK symbol that includes at least a portion of the PRS. In some examples, the WUS may be communicated as described with reference to FIG. 4.

At 830, the wireless device 415-b may output (e.g., transmit), or the network entity 855 may obtain (e.g., receive), measurement information (e.g., information that is based on a position measurement). In some examples, the measurement information may be communicated as described with reference to FIG. 4.

At 835, the network entity 855 may perform a position determination. For instance, the position determination as described with reference to FIG. 4. In some aspects, the network entity 855 may perform one or more positioning procedures to determine a position of the wireless device 415-b as described with reference to FIG. 4 or FIG. 27.

At 840, the network entity 855 may output (e.g., transmit), or the wireless device 415-b may obtain (e.g., receive), position information. For instance, the position information may indicate the position of the wireless device 415-b and may be communicated as described herein.

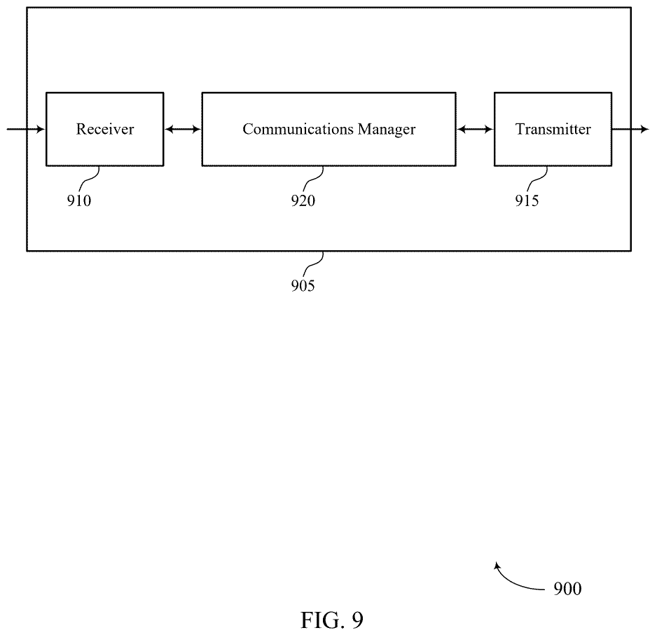

FIG. 9 shows a block diagram 900 of a device 905 that supports PRSs via WUSs in accordance with one or more aspects of the present disclosure. The device 905 may be an example of aspects of a wireless device as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to PRSs via WUSs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to PRSs via WUSs). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of PRSs via WUSs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for receiving a WUS that includes an OOK symbol, where the OOK symbol includes at least a portion of a PRS. The communications manager 920 is capable of, configured to, or operable to support a means for determining a position measurement based on the at least a portion of the PRS.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, or more efficient utilization of communication resources.

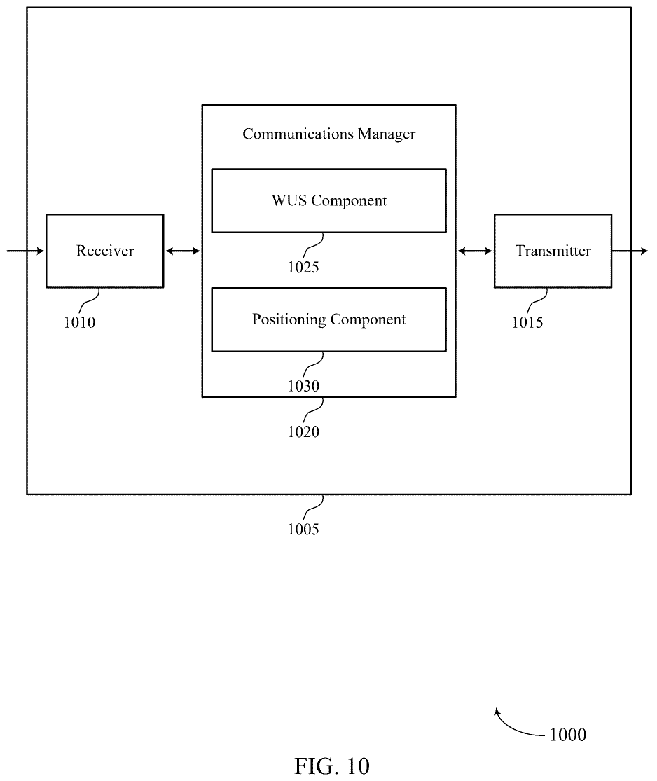

FIG. 10 shows a block diagram 1000 of a device 1005 that supports PRSs via WUSs in accordance with one or more aspects of the present disclosure. The device 1005 may be an example of aspects of a device 905 or a wireless device as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to PRSs via WUSs). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to PRSs via WUSs). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of PRSs via WUSs as described herein. For example, the communications manager 1020 may include a WUS component 1025 a positioning component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The WUS component 1025 is capable of, configured to, or operable to support a means for receiving a WUS that includes an OOK symbol, where the OOK symbol includes at least a portion of a PRS. The positioning component 1030 is capable of, configured to, or operable to support a means for determining a position measurement based on the at least a portion of the PRS.

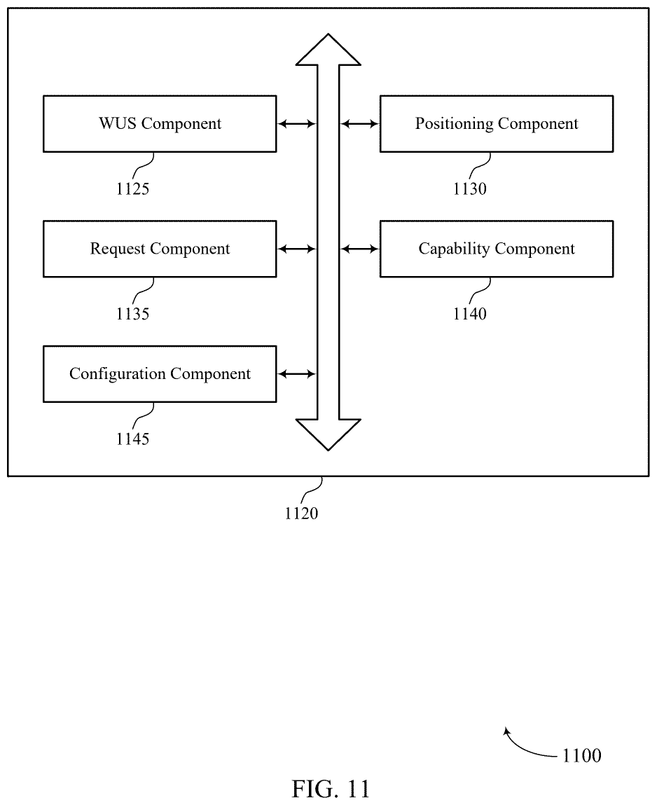

FIG. 11 shows a block diagram 1100 of a communications manager 1120 that supports PRSs via WUSs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of PRSs via WUSs as described herein. For example, the communications manager 1120 may include a WUS component 1125, a positioning component 1130, a request component 1135, a capability component 1140, a configuration component 1145, or any combination thereof. Each of these components, or components or subcomponents thereof (e.g., one or more processors, one or more memories), may communicate, directly or indirectly, with one another (e.g., via one or more buses).

The WUS component 1125 is capable of, configured to, or operable to support a means for receiving a WUS that includes an OOK symbol, where the OOK symbol includes at least a portion of a PRS. The positioning component 1130 is capable of, configured to, or operable to support a means for determining a position measurement based on the at least a portion of the PRS.

In some examples, to support participating in the positioning procedure, the positioning component 1130 is capable of, configured to, or operable to support a means for generating information based on the position measurement of the at least a portion of the PRS. In some examples, to support participating in the positioning procedure, the positioning component 1130 is capable of, configured to, or operable to support a means for transmitting, to a network entity, the information that is based on the position measurement of the PRS.

In some examples, the at least a portion of the PRS is carried on one or more OOK symbols with an on state in a duration of an OFDM symbol.

In some examples, the OOK symbol has a same duration as an OFDM symbol, and the at least a portion of the PRS is modulated in the frequency domain on one or more subcarriers for the WUS.

In some examples, the OOK symbol has a shorter duration than an OFDM symbol, and the at least a portion of the PRS is a time domain signal (or a signal generated in the time domain).

In some examples, the OOK symbol has a shorter duration than an OFDM symbol, and the at least a portion of the PRS is modulated in the frequency domain with a first SCS that is a quantity (e.g., M, an integer, or another quantity) times a second SCS of the OFDM symbol.

In some examples, multiple PRSs are time-division multiplexed in the WUS or across multiple WUSs.

In some examples, a first PRS of the multiple PRSs corresponds to a first cell and a second PRS of the multiple PRSs corresponds to a second cell. In some examples, the first PRS is communicated via a first quantity of OOK symbols and the second PRS is communicated via a second quantity of OOK symbols that is different from the first quantity of symbols.

In some examples, the at least a portion of the PRS spans a single OOK symbol, multiple OOK symbols, or all OOK symbols of the WUS.

In some examples, the at least a portion of the PRS is frequency-division multiplexed on the WUS in accordance with a comb.

In some examples, a resource for communication of PRS signaling repeats based on a quantity of OOK symbols, a quantity of orthogonal frequency-division multiplexing (OFDM) symbols, a quantity of slots, or a quantity of WUS repetitions.

In some examples, the request component 1135 is capable of, configured to, or operable to support a means for outputting, to a network entity, a request for the WUS that includes the OOK symbol that includes the at least a portion of the PRS, where the WUS is received based on the request.

In some examples, the capability component 1140 is capable of, configured to, or operable to support a means for outputting, to a network entity, capability information indicating a capability of the wireless device to receive the WUS that includes the OOK symbol that includes the at least a portion of the PRS.

In some examples, the configuration component 1145 is capable of, configured to, or operable to support a means for obtaining, from a network entity, configuration information indicating that the wireless device is to receive the WUS that includes the OOK symbol that includes the at least a portion of the PRS.

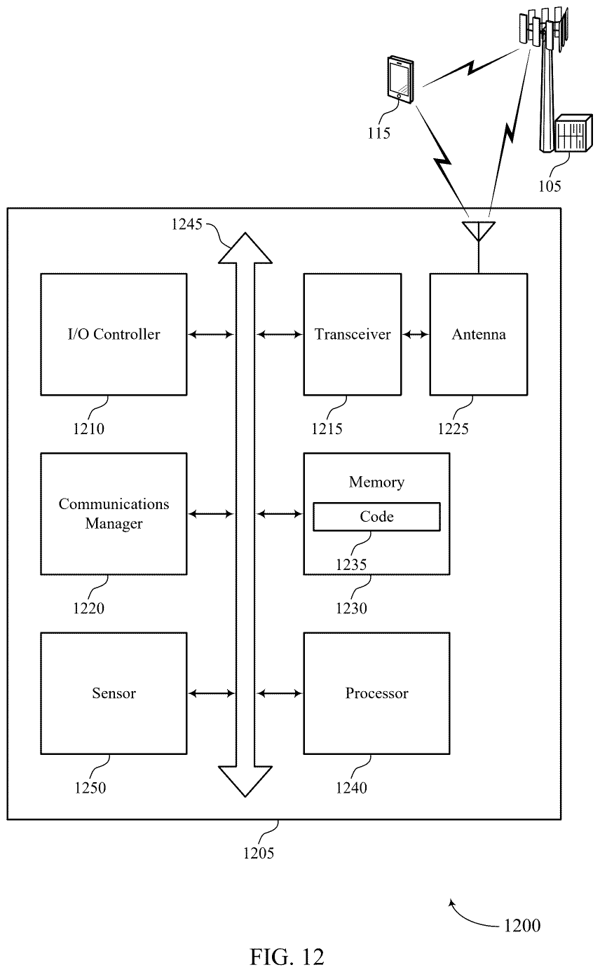

FIG. 12 shows a diagram of a system 1200 including a device 1205 that supports PRSs via WUSs in accordance with one or more aspects of the present disclosure. The device 1205 may be an example of or include components of a device 905, a device 1005, or a wireless device 415 as described herein. The device 1205 may include components for bi-directional voice and data communications including components for transmitting and receiving communications, such as a communications manager 1220, an I/O controller, such as an I/O controller 1210, one or more transceivers 1215, one or more antennas 1225, at least one memory 1230, code 1235, and at least one processor 1240. The device 1205 may include one or more sensors 1250. These components may be in electronic communication or otherwise coupled (e.g., operatively, communicatively, functionally, electronically, electrically) via one or more buses (e.g., a bus 1245). The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver(s) 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The one or more transceivers 1215 may include one or more wireless wide area network (WWAN) transceivers, one or more short-range wireless transceivers, or one or more satellite transceivers. The WWAN transceiver(s) may communicate with (e.g., transmit one or more signals to, or receive one or more signals from) one or more wireless communication networks, such as an NR network, an LTE network, or a GSM network, among other examples. The WWAN transceiver(s) may be connected to one or more of the antenna(s) 1225 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1225 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), or ultra-wideband (UWB), among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, vehicle-to-vehicle (V2V) transceivers, or vehicle-to-everything (V2X) transceivers, among other examples.

The satellite transceiver(s) may include one or more satellite signal receivers, or one or more satellite signal transmitters. In some cases, the device 1205 may be a terrestrial device that may communicate one or more satellites via the satellite transceiver(s). In other cases, device 1205 may be a satellite (or other non-terrestrial entity) that uses the satellite transceiver(s) to communicate with one or more terrestrial networks or other satellites.

The satellite signal receiver(s) may be connected to one or more of the antenna(s) 1225 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, Indian Regional Navigation Satellite System (NAVIC), or Quasi-Zenith Satellite System (QZSS) signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1240 may perform calculations to determine a location of the device 1205, the UE 115, the network node 105, or another device using measurements obtained from one or more satellite signals.

The one or more satellite signal transmitters may be connected to one or more of the antennas 1225 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The device 1205 may include one or more sensors 1250 coupled with the one or more processors 1240 for obtaining sensor data (e.g., image data, RF data, motion data, orientation data, or audio data, among other examples). For example, the one or more sensors 1250 may sense or detect movement or orientation information. In some aspects, the movement or orientation information may be independent from motion data derived from signals received by the one or more WWAN transceivers, the one or more short-range wireless transceivers, or the satellite signal interface. In some examples, the sensor(s) 1250 may include an accelerometer (e.g., a micro-electrical mechanical systems (MEMS) device), a gyroscope, a geomagnetic sensor (e.g., a compass), an altimeter (e.g., a barometric pressure altimeter), or any other type of movement detection sensor. Additionally, or alternatively, the one or more sensors 1250 may include an image sensor, camera, microphone, light detector, or pressure sensor, among other examples. In some aspects, the sensor(s) 1250 may include a plurality of different types of devices, and the device 1205 (e.g., sensor(s) or 1250 processor(s) 1240) may combine the outputs of the different types of devices to provide motion information. For example, the sensor(s) 1250 may use a combination of a multi-axis accelerometer sensors, orientation sensors, or image sensors to provide the ability to compute positions in two-dimensional (2D) or three-dimensional (3D) coordinate systems.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting signaling for PRSs via WUSs). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

For example, the communications manager 1220 is capable of, configured to, or operable to support a means for receiving a WUS that includes an OOK symbol, where the OOK symbol includes at least a portion of a PRS. The communications manager 1220 is capable of, configured to, or operable to support a means for determining a position measurement based on the at least a portion of the PRS.

By including or configuring the communications manager 1220 in accordance with examples as described herein, the device 1205 may support techniques for enhanced positioning accuracy, improved communication reliability, reduced latency, reduced power consumption, more efficient utilization of communication resources, improved coordination between devices, longer battery life, or improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of PRSs via WUSs as described herein, or the at least one processor 1240 and the at least one memory 1230 may be otherwise configured to, individually or collectively, perform or support such operations.

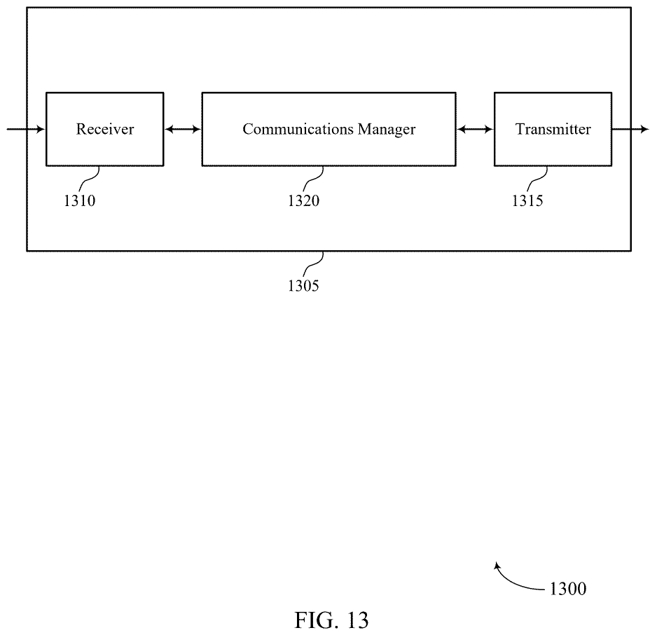

FIG. 13 shows a block diagram 1300 of a device 1305 that supports PRSs via WUSs in accordance with one or more aspects of the present disclosure. The device 1305 may be an example of aspects of a network node as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of PRSs via WUSs as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

For example, the communications manager 1320 is capable of, configured to, or operable to support a means for transmitting a WUS that includes an OOK symbol, where the OOK symbol includes at least a portion of a PRS. The communications manager 1320 is capable of, configured to, or operable to support a means for receiving information that is based on a position measurement of the at least a portion of the PRS.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing, reduced power consumption, or more efficient utilization of communication resources.

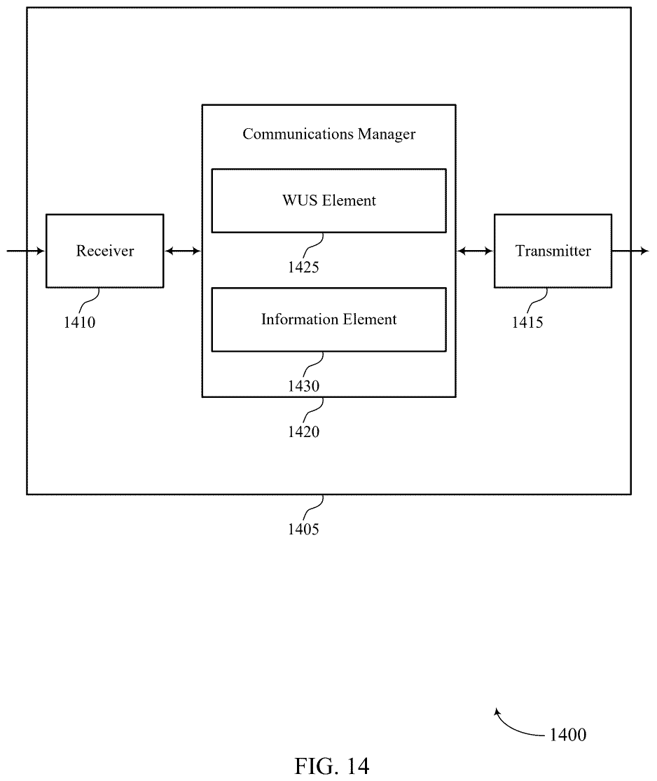

FIG. 14 shows a block diagram 1400 of a device 1405 that supports PRSs via WUSs in accordance with one or more aspects of the present disclosure. The device 1405 may be an example of aspects of a device 1305 or a network node as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of PRSs via WUSs as described herein. For example, the communications manager 1420 may include a WUS element 1425 an information element 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The WUS element 1425 is capable of, configured to, or operable to support a means for transmitting a WUS that includes an OOK symbol, where the OOK symbol includes at least a portion of a PRS. The information element 1430 is capable of, configured to, or operable to support a means for receiving information that is based on a position measurement of the at least a portion of the PRS.

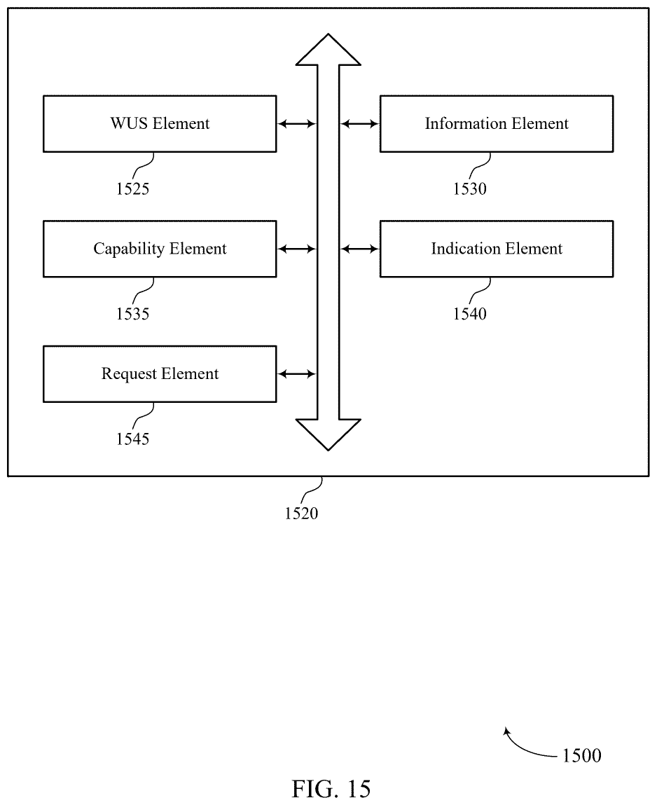

FIG. 15 shows a block diagram 1500 of a communications manager 1520 that supports PRSs via WUSs in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of PRSs via WUSs as described herein. For example, the communications manager 1520 may include a WUS element 1525, an information element 1530, a capability element 1535, an indication element 1540, a request element 1545, or any combination thereof. Each of these components, or components or subcomponents thereof (e.g., one or more processors, one or more memories), may communicate, directly or indirectly, with one another (e.g., via one or more buses).

The WUS element 1525 is capable of, configured to, or operable to support a means for transmitting a WUS that includes an OOK symbol, where the OOK symbol includes at least a portion of a PRS. The information element 1530 is capable of, configured to, or operable to support a means for receiving information that is based on a position measurement of the at least a portion of the PRS.

In some examples, the at least a portion of the PRS is carried on one or more OOK symbols with an on state in a duration of an OFDM symbol.

In some examples, the OOK symbol has a same duration as an OFDM symbol, and the at least a portion of the PRS is modulated in the frequency domain on one or more subcarriers for the WUS.

In some examples, the OOK symbol has a shorter duration than an OFDM symbol, and the at least a portion of the PRS is a time domain signal (or a signal generated in the time domain).

In some examples, the OOK symbol has a shorter duration than an OFDM symbol, and the at least a portion of the PRS is modulated in the frequency domain with a first SCS that is a quantity (e.g., M, an integer, or another quantity) times a second SCS of the OFDM symbol.

In some examples, multiple PRSs are time-division multiplexed in the WUS or across multiple WUSs.

In some examples, a first PRS of the multiple PRSs corresponds to a first cell and a second PRS of the multiple PRSs corresponds to a second cell. In some examples, the first PRS is communicated via a first quantity of OOK symbols and the second PRS is communicated via a second quantity of OOK symbols that is different from the first quantity of symbols.

In some examples, the at least a portion of the PRS spans a single OOK symbol, multiple OOK symbols, or all OOK symbols of the WUS.

In some examples, the at least a portion of the PRS is frequency-division multiplexed on the WUS in accordance with a comb.

In some examples, a resource for communication of PRS signaling repeats based on a quantity of OOK symbols, a quantity of OFDM symbols, a quantity of slots, or a quantity of WUS repetitions.

In some examples, the capability element 1535 is capable of, configured to, or operable to support a means for outputting, to a network entity, capability information indicating that the network node is capable of transmitting the at least a portion of the PRS (overlaid with the OOK symbol of the WUS, for instance).

In some examples, the indication element 1540 is capable of, configured to, or operable to support a means for outputting, to a network entity, an indication of a periodicity of PRS signaling on WUS signaling that the network node is capable of transmitting, an indication of a type of PRS signaling on WUS signaling that the network node is capable of transmitting, a bandwidth of PRS signaling on WUS signaling that the network node supports, a duration of WUS signaling via which PRS signaling is supported by the network node, an indication of one or more activity modes the network node supports for PRS signaling on WUS signaling, or an indication of whether PRS signaling on WUS signaling during a CDRX is supported by the network node, or any combination thereof.

In some examples, the request element 1545 is capable of, configured to, or operable to support a means for obtaining, from a network entity, a request for an indication of a pattern of the WUS corresponding to a wireless device. In some examples, the indication element 1540 is capable of, configured to, or operable to support a means for outputting, to the network entity, the indication of the pattern of the WUS corresponding to the wireless device based on the request.

In some examples, the request element 1545 is capable of, configured to, or operable to support a means for obtaining, from a network entity, a request that the network node transmit the at least a portion of the PRS in accordance with a pattern, where transmitting the WUS that includes the OOK symbol is based on the pattern.

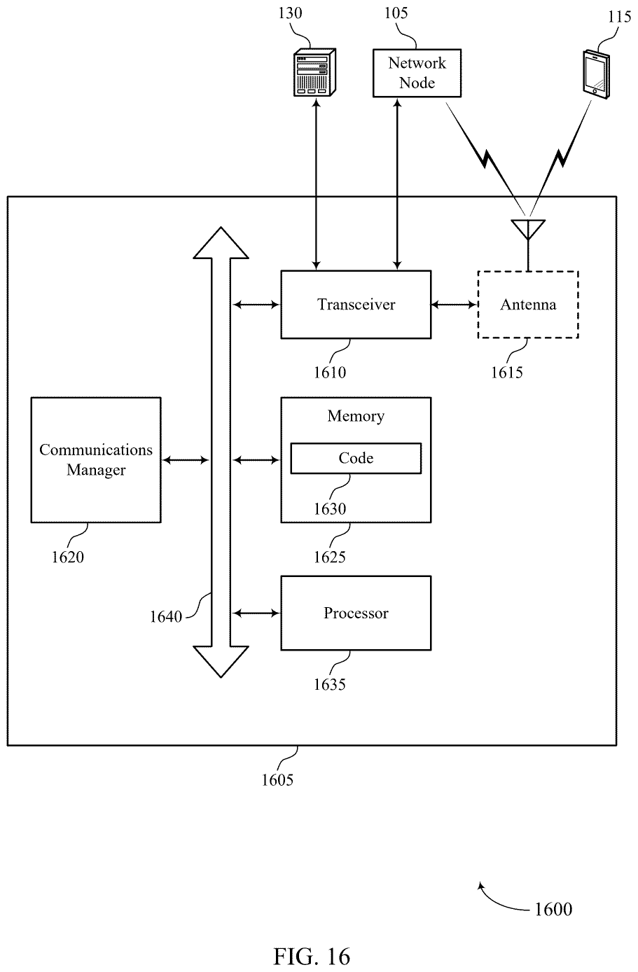

FIG. 16 shows a diagram of a system 1600 including a device 1605 that supports PRSs via WUSs in accordance with one or more aspects of the present disclosure. The device 1605 may be an example of or include components of a device 1305, a device 1405, or a network entity as described herein. The device 1605 may include components for bi-directional voice and data communications including components for transmitting and receiving communications, such as a communications manager 1620, one or more transceivers 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The one or more transceivers 1610 may include one or more WWAN transceivers, one or more short-range wireless transceivers, or one or more satellite transceivers. The WWAN transceiver(s) may communicate with (e.g., transmit one or more signals to, or receive one or more signals from) one or more wireless devices, such as the network node 105 or the UE 115, among other examples. The WWAN transceiver(s) may be connected to one or more of the antenna(s) 1615 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1615 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, DSRC, WAVE, NFC, or UWB, among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, V2V transceivers, or V2X transceivers, among other examples.

The satellite transceiver(s) may include one or more satellite signal receivers, or one or more satellite signal transmitters. In some cases, the device 1605 may be a terrestrial device that may communicate one or more satellites via the satellite transceiver(s). In other cases, device 1605 may be a satellite (or other non-terrestrial entity) that uses the satellite transceiver(s) to communicate with one or more terrestrial networks or other satellites.

The satellite signal receiver(s) may be connected to one or more of the antenna(s) 1615 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, NAVIC, or QZSS signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1635 may perform calculations to determine a location of the device 1605, the UE 115, the network node 105, or another device using measurements obtained from one or more satellite signals.

The one or more satellite signal transmitters may be connected to one or more of the antennas 1615 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting signaling for PRSs via WUSs). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network nodes 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network nodes 105.

For example, the communications manager 1620 is capable of, configured to, or operable to support a means for transmitting a WUS that includes an OOK symbol, where the OOK symbol includes at least a portion of a PRS. The communications manager 1620 is capable of, configured to, or operable to support a means for receiving information that is based on a position measurement of the at least a portion of the PRS.

By including or configuring the communications manager 1620 in accordance with examples as described herein, the device 1605 may support techniques for increased positioning accuracy, improved communication reliability, reduced latency, improved user experience related to reduced processing, reduced power consumption, more efficient utilization of communication resources, improved coordination between devices, longer battery life, improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of PRSs via WUSs as described herein, or the at least one processor 1635 and the at least one memory 1625 may be otherwise configured to, individually or collectively, perform or support such operations.

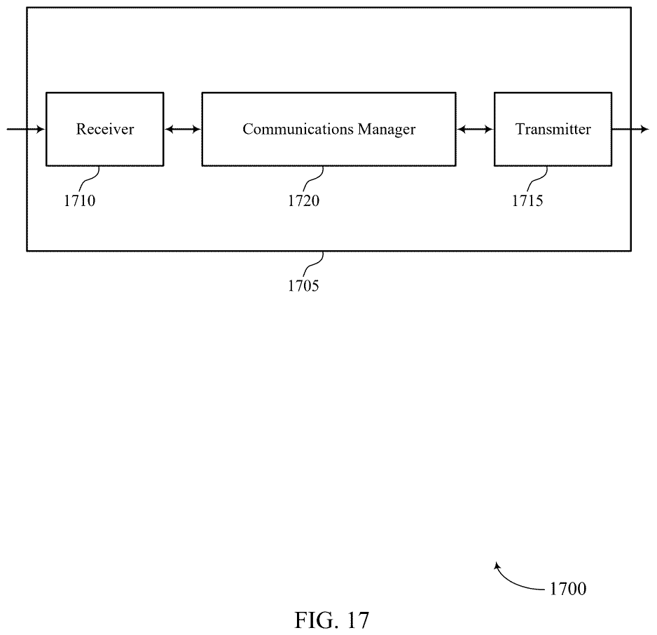

FIG. 17 shows a block diagram 1700 of a device 1705 that supports PRSs via WUSs in accordance with one or more aspects of the present disclosure. The device 1705 may be an example of aspects of a network entity as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to, individually or collectively, support or enable the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The communications manager 1720, the receiver 1710, the transmitter 1715, or various combinations or components thereof may be examples of means for performing various aspects of PRSs via WUSs as described herein. For example, the communications manager 1720, the receiver 1710, the transmitter 1715, or various combinations or components thereof may be capable of performing one or more of the functions described herein.

In some examples, the communications manager 1720, the receiver 1710, the transmitter 1715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1720, the receiver 1710, the transmitter 1715, or various combinations or components thereof may be implemented in code (e.g., as communications management software or firmware) executed by at least one processor (e.g., referred to as a processor-executable code). If implemented in code executed by at least one processor, the functions of the communications manager 1720, the receiver 1710, the transmitter 1715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1720 may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

For example, the communications manager 1720 is capable of, configured to, or operable to support a means for obtaining, from a network node, capability information indicating that the network node is capable of transmitting at least a portion of a PRS included in an OOK symbol of a WUS. The communications manager 1720 is capable of, configured to, or operable to support a means for outputting, to the network node, configuration information indicating that the network node is to transmit the at least a portion of the PRS included in the OOK symbol of a WUS.

By including or configuring the communications manager 1720 in accordance with examples as described herein, the device 1705 (e.g., at least one processor controlling or otherwise coupled with the receiver 1710, the transmitter 1715, the communications manager 1720, or a combination thereof) may support techniques for reduced processing, reduced power consumption, or more efficient utilization of communication resources.

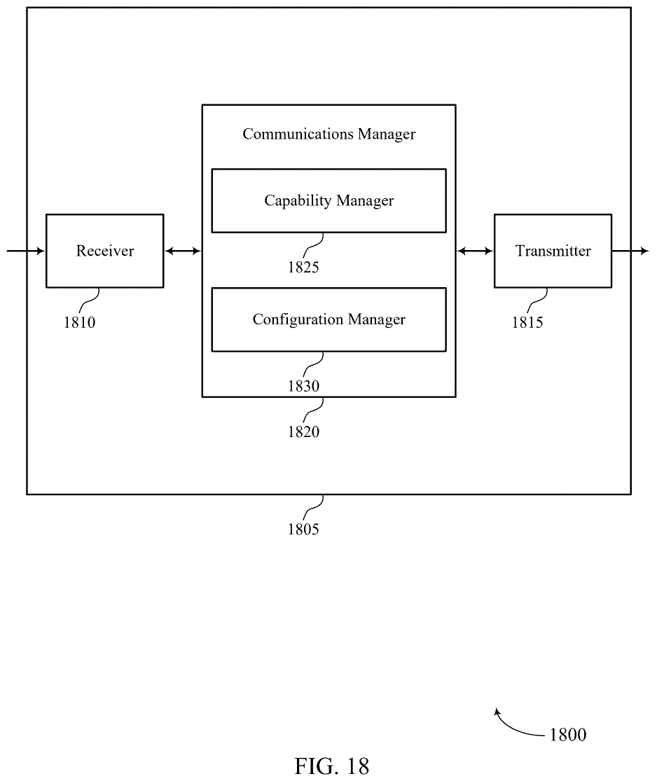

FIG. 18 shows a block diagram 1800 of a device 1805 that supports PRSs via WUSs in accordance with one or more aspects of the present disclosure. The device 1805 may be an example of aspects of a device 1705 or a network entity as described herein. The device 1805 may include a receiver 1810, a transmitter 1815, and a communications manager 1820. The device 1805, or one or more components of the device 1805 (e.g., the receiver 1810, the transmitter 1815, the communications manager 1820), may include at least one processor, which may be coupled with at least one memory, to support the described techniques. Each of these components may be in communication with one another (e.g., via one or more buses).

The receiver 1810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1805. In some examples, the receiver 1810 may support obtaining information by receiving signals via one or more antennas. Additionally, or alternatively, the receiver 1810 may support obtaining information by receiving signals via one or more wired (e.g., electrical, fiber optic) interfaces, wireless interfaces, or any combination thereof.

The transmitter 1815 may provide a means for outputting (e.g., transmitting, providing, conveying, sending) information generated by other components of the device 1805. For example, the transmitter 1815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1815 may support outputting information by transmitting signals via one or more antennas. Additionally, or alternatively, the transmitter 1815 may support outputting information by transmitting signals via one or more wired (e.g., electrical, fiber optic) interfaces, wireless interfaces, or any combination thereof. In some examples, the transmitter 1815 and the receiver 1810 may be co-located in a transceiver, which may include or be coupled with a modem.

The device 1805, or various components thereof, may be an example of means for performing various aspects of PRSs via WUSs as described herein. For example, the communications manager 1820 may include a capability manager 1825 a configuration manager 1830, or any combination thereof. The communications manager 1820 may be an example of aspects of a communications manager 1720 as described herein. In some examples, the communications manager 1820, or various components thereof, may be configured to perform various operations (e.g., receiving, obtaining, monitoring, outputting, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to obtain information, output information, or perform various other operations as described herein.

The capability manager 1825 is capable of, configured to, or operable to support a means for obtaining, from a network node, capability information indicating that the network node is capable of transmitting at least a portion of a PRS included in an OOK symbol of a WUS. The configuration manager 1830 is capable of, configured to, or operable to support a means for outputting, to the network node, configuration information indicating that the network node is to transmit the at least a portion of the PRS (included in or overlaid with the OOK symbol of a WUS, for instance).

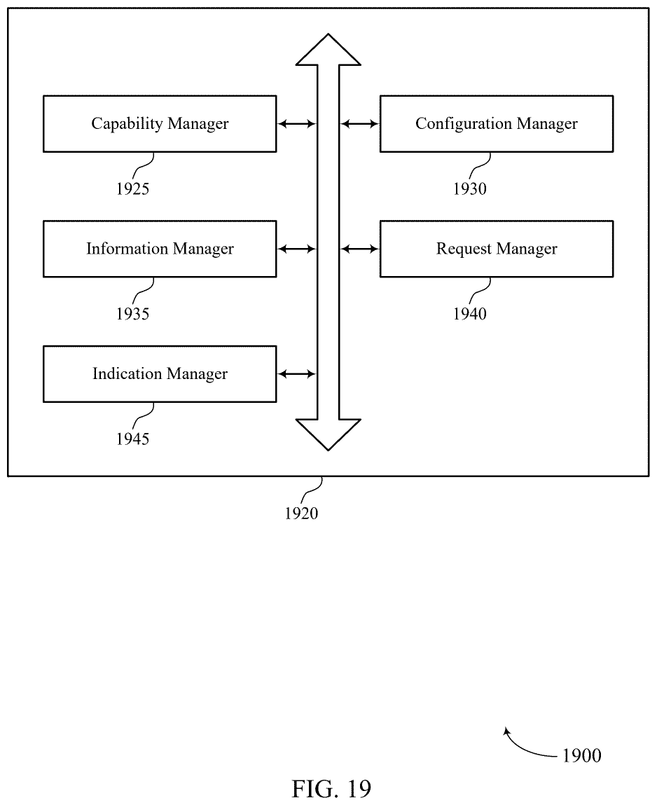

FIG. 19 shows a block diagram 1900 of a communications manager 1920 that supports PRSs via WUSs in accordance with one or more aspects of the present disclosure. The communications manager 1920 may be an example of aspects of a communications manager 1720, a communications manager 1820, or both, as described herein. The communications manager 1920, or various components thereof, may be an example of means for performing various aspects of PRSs via WUSs as described herein. For example, the communications manager 1920 may include a capability manager 1925, a configuration manager 1930, an information manager 1935, a request manager 1940, an indication manager 1945, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity, between devices, components, or virtualized components associated with a network entity), or any combination thereof.

The capability manager 1925 is capable of, configured to, or operable to support a means for obtaining, from a network node, capability information indicating that the network node is capable of transmitting at least a portion of a PRS included in an OOK symbol of a WUS. The configuration manager 1930 is capable of, configured to, or operable to support a means for outputting, to the network node, configuration information indicating that the network node is to transmit the at least a portion of the PRS included in the OOK symbol of a WUS.

In some examples, the information manager 1935 is capable of, configured to, or operable to support a means for receiving information that is based on a position measurement of the at least a portion of the PRS included in the OOK symbol.

In some examples, the capability information includes an indication of a periodicity of PRS signaling on WUS signaling that the network node is capable of transmitting, an indication of a type of PRS signaling on WUS signaling that the network node is capable of transmitting, a bandwidth of PRS signaling on WUS signaling that the network node supports, a duration of WUS signaling via which PRS signaling is supported by the network node, an indication of one or more activity modes the network node supports for PRS signaling on WUS signaling, or an indication of whether PRS signaling on WUS signaling during a CDRX is supported by the network node, or any combination thereof. In some examples, the configuration information is based on the capability information.

In some examples, the request manager 1940 is capable of, configured to, or operable to support a means for outputting, to the network node, a request for an indication of a pattern of the WUS corresponding to a wireless device. In some examples, the indication manager 1945 is capable of, configured to, or operable to support a means for obtaining, from the network node, the indication of the pattern of the WUS corresponding to the wireless device based on the request.

In some examples, the request manager 1940 is capable of, configured to, or operable to support a means for outputting, to the network node, a request that the network node transmit the at least a portion of the PRS in accordance with a pattern.

In some examples, the request manager 1940 is capable of, configured to, or operable to support a means for obtaining, from a wireless device, a request for the WUS that includes the OOK symbol that includes the at least a portion of the PRS, where the configuration information is output based on the request.

In some examples, the capability manager 1925 is capable of, configured to, or operable to support a means for obtaining, from a wireless device, capability information indicating a capability of the wireless device to receive the WUS that includes the OOK symbol that includes the at least a portion of the PRS.

In some examples, the configuration manager 1930 is capable of, configured to, or operable to support a means for outputting, to a wireless device, configuration information indicating that the wireless device is to receive the WUS that includes the OOK symbol that includes the at least a portion of the PRS.

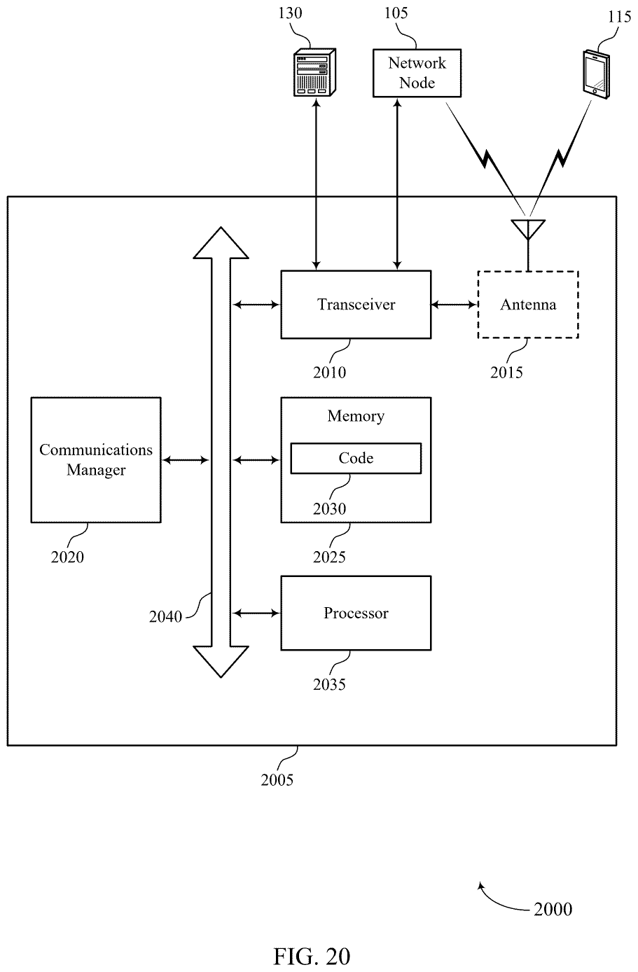

FIG. 20 shows a diagram of a system 2000 including a device 2005 that supports PRSs via WUSs in accordance with one or more aspects of the present disclosure. The device 2005 may be an example of or include components of a device 1305, a device 1405, or a network entity as described herein. The device 2005 may include components for bi-directional voice and data communications including components for transmitting and receiving communications, such as a communications manager 2020, one or more transceivers 2010, one or more antennas 2015, at least one memory 2025, code 2030, and at least one processor 2035. These components may be in electronic communication or otherwise coupled (e.g., operatively, communicatively, functionally, electronically, electrically) via one or more buses (e.g., a bus 2040).

The transceiver 2010 may support bi-directional communications via wired links, wireless links, or both as described herein. In some examples, the transceiver 2010 may include a wired transceiver and may communicate bi-directionally with another wired transceiver. Additionally, or alternatively, in some examples, the transceiver 2010 may include a wireless transceiver and may communicate bi-directionally with another wireless transceiver. In some examples, the device 2005 may include one or more antennas 2015, which may be capable of transmitting or receiving wireless transmissions (e.g., concurrently). The transceiver 2010 may also include a modem to modulate signals, to provide the modulated signals for transmission (e.g., by one or more antennas 2015, by a wired transmitter), to receive modulated signals (e.g., from one or more antennas 2015, from a wired receiver), and to demodulate signals. In some implementations, the transceiver 2010 may include one or more interfaces, such as one or more interfaces coupled with the one or more antennas 2015 that are configured to support various receiving or obtaining operations, or one or more interfaces coupled with the one or more antennas 2015 that are configured to support various transmitting or outputting operations, or a combination thereof. In some implementations, the transceiver 2010 may include or be configured for coupling with one or more processors or one or more memory components that are operable to perform or support operations based on received or obtained information or signals, or to generate information or other signals for transmission or other outputting, or any combination thereof. In some implementations, the transceiver 2010, or the transceiver 2010 and the one or more antennas 2015, or the transceiver 2010 and the one or more antennas 2015 and one or more processors or one or more memory components (e.g., the at least one processor 2035, the at least one memory 2025, or both), may be included in a chip or chip assembly that is installed in the device 2005. In some examples, the transceiver 2010 may be operable to support communications via one or more communications links (e.g., communication link(s) 125, backhaul communication link(s) 120, a midhaul communication link 162, a fronthaul communication link 168).

The one or more transceivers 2010 may include one or more WWAN transceivers, one or more short-range wireless transceivers, or one or more satellite transceivers. The WWAN transceiver(s) may communicate with (e.g., transmit one or more signals to, or receive one or more signals from) one or more wireless devices, such as the network node 105 or the UE 115, among other examples. The WWAN transceiver(s) may be connected to one or more of the antenna(s) 2015 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 2015 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, DSRC, WAVE, NFC, or UWB, among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, V2V transceivers, or V2X transceivers, among other examples.

The satellite transceiver(s) may include one or more satellite signal receivers, or one or more satellite signal transmitters. In some cases, the device 2005 may be a terrestrial device that may communicate one or more satellites via the satellite transceiver(s). In other cases, device 2005 may be a satellite (or other non-terrestrial entity) that uses the satellite transceiver(s) to communicate with one or more terrestrial networks or other satellites.

The satellite signal receiver(s) may be connected to one or more of the antenna(s) 2015 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, NAVIC, or QZSS signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 2035 may perform calculations to determine a location of the device 2005, the UE 115, the network node 105, or another device using measurements obtained from one or more satellite signals.

The one or more satellite signal transmitters may be connected to one or more of the antennas 2015 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The at least one memory 2025 may include RAM, ROM, or any combination thereof. The at least one memory 2025 may store computer-readable, computer-executable, or processor-executable code, such as the code 2030. The code 2030 may include instructions that, when executed by one or more of the at least one processor 2035, cause the device 2005 to perform various functions described herein. The code 2030 may be stored in a non-transitory computer-readable medium such as system memory or another type of memory. In some cases, the code 2030 may not be directly executable by a processor of the at least one processor 2035 but may cause a computer (e.g., when compiled and executed) to perform functions described herein. In some cases, the at least one memory 2025 may include, among other things, a BIOS which may control basic hardware or software operation such as the interaction with peripheral components or devices. In some examples, the at least one processor 2035 may include multiple processors and the at least one memory 2025 may include multiple memories. One or more of the multiple processors may be coupled with one or more of the multiple memories which may, individually or collectively, be configured to perform various functions herein (for example, as part of a processing system).

The at least one processor 2035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 2035 may be configured to operate a memory array using a memory controller. In some other cases, a memory controller may be integrated into one or more of the at least one processor 2035. The at least one processor 2035 may be configured to execute computer-readable instructions stored in a memory (e.g., one or more of the at least one memory 2025) to cause the device 2005 to perform various functions (e.g., functions or tasks supporting PRSs via WUSs). For example, the device 2005 or a component of the device 2005 may include at least one processor 2035 and at least one memory 2025 coupled with one or more of the at least one processor 2035, the at least one processor 2035 and the at least one memory 2025 configured to perform various functions described herein. The at least one processor 2035 may be an example of a cloud-computing platform (e.g., one or more physical nodes and supporting software such as operating systems, virtual machines, or container instances) that may host the functions (e.g., by executing code 2030) to perform the functions of the device 2005. The at least one processor 2035 may be any one or more suitable processors capable of executing scripts or instructions of one or more software programs stored in the device 2005 (such as within one or more of the at least one memory 2025).

In some examples, the at least one processor 2035 may include multiple processors and the at least one memory 2025 may include multiple memories. One or more of the multiple processors may be coupled with one or more of the multiple memories, which may, individually or collectively, be configured to perform various functions herein. In some examples, the at least one processor 2035 may be a component of a processing system, which may refer to a system (such as a series) of machines, circuitry (including, for example, one or both of processor circuitry (which may include the at least one processor 2035) and memory circuitry (which may include the at least one memory 2025)), or components, that receives or obtains inputs and processes the inputs to produce, generate, or obtain a set of outputs. The processing system may be configured to perform one or more of the functions described herein. For example, the at least one processor 2035 or a processing system including the at least one processor 2035 may be configured to, configurable to, or operable to cause the device 2005 to perform one or more of the functions described herein. Further, as described herein, being “configured to,” being “configurable to,” and being “operable to” may be used interchangeably and may be associated with a capability, when executing code stored in the at least one memory 2025 or otherwise, to perform one or more of the functions described herein.

In some examples, a bus 2040 may support communications of (e.g., within) a protocol layer of a protocol stack. In some examples, a bus 2040 may support communications associated with a logical channel of a protocol stack (e.g., between protocol layers of a protocol stack), which may include communications performed within a component of the device 2005, or between different components of the device 2005 that may be co-located or located in different locations (e.g., where the device 2005 may refer to a system in which one or more of the communications manager 2020, the transceiver 2010, the at least one memory 2025, the code 2030, and the at least one processor 2035 may be located in one of the different components or divided between different components).

In some examples, the communications manager 2020 may manage aspects of communications with a core network 130 (e.g., via one or more wired or wireless backhaul links). For example, the communications manager 2020 may manage the transfer of data communications for client devices, such as one or more UEs 115. In some examples, the communications manager 2020 may manage communications with one or more other network nodes 105, and may include a controller or scheduler for controlling communications with UEs 115 (e.g., in cooperation with the one or more other network devices). In some examples, the communications manager 2020 may support an X2 interface within an LTE/LTE-A wireless communications network technology to provide communication between network nodes 105.

For example, the communications manager 2020 is capable of, configured to, or operable to support a means for obtaining, from a network node, capability information indicating that the network node is capable of transmitting at least a portion of a PRS included in an OOK symbol of a WUS. The communications manager 2020 is capable of, configured to, or operable to support a means for outputting, to the network node, configuration information indicating that the network node is to transmit the at least a portion of the PRS included in the OOK symbol of a WUS.

By including or configuring the communications manager 2020 in accordance with examples as described herein, the device 2005 may support techniques for increased positioning accuracy, improved communication reliability, reduced latency, improved user experience related to reduced processing, reduced power consumption, more efficient utilization of communication resources, improved coordination between devices, longer battery life, improved utilization of processing capability.

In some examples, the communications manager 2020 may be configured to perform various operations (e.g., receiving, obtaining, monitoring, outputting, transmitting) using or otherwise in cooperation with the transceiver 2010, the one or more antennas 2015 (e.g., where applicable), or any combination thereof. Although the communications manager 2020 is illustrated as a separate component, in some examples, one or more functions described with reference to the communications manager 2020 may be supported by or performed by the transceiver 2010, one or more of the at least one processor 2035, one or more of the at least one memory 2025, the code 2030, or any combination thereof (for example, by a processing system including at least a portion of the at least one processor 2035, the at least one memory 2025, the code 2030, or any combination thereof). For example, the code 2030 may include instructions executable by one or more of the at least one processor 2035 to cause the device 2005 to perform various aspects of PRSs via WUSs as described herein, or the at least one processor 2035 and the at least one memory 2025 may be otherwise configured to, individually or collectively, perform or support such operations.

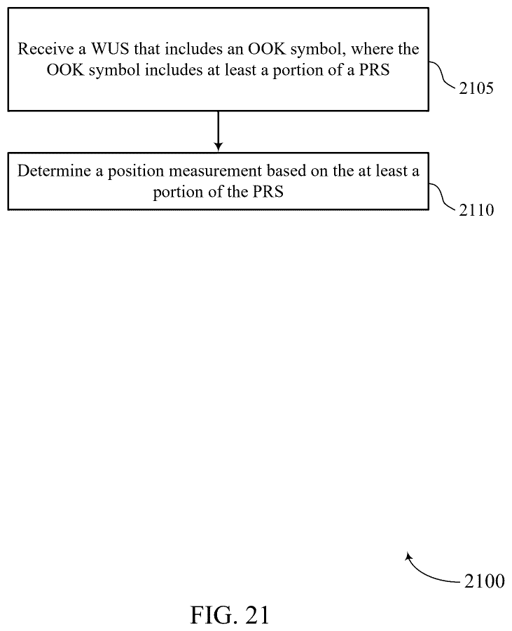

FIG. 21 shows a flowchart illustrating a method 2100 that supports PRSs via WUSs in accordance with one or more aspects of the present disclosure. The operations of the method 2100 may be implemented by a wireless device or its components as described herein. For example, the operations of the method 2100 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

At 2105, the method may include receiving a WUS that includes an OOK symbol, where the OOK symbol includes at least a portion of a PRS. The operations of 2105 may be performed in accordance with examples as disclosed herein. In some examples, aspects of the operations of 2105 may be performed by a WUS component 1125 as described with reference to FIG. 11.

At 2110, the method may include determining a position measurement based on the at least a portion of the PRS. The operations of 2110 may be performed in accordance with examples as disclosed herein. In some examples, aspects of the operations of 2110 may be performed by a positioning component 1130 as described with reference to FIG. 11.

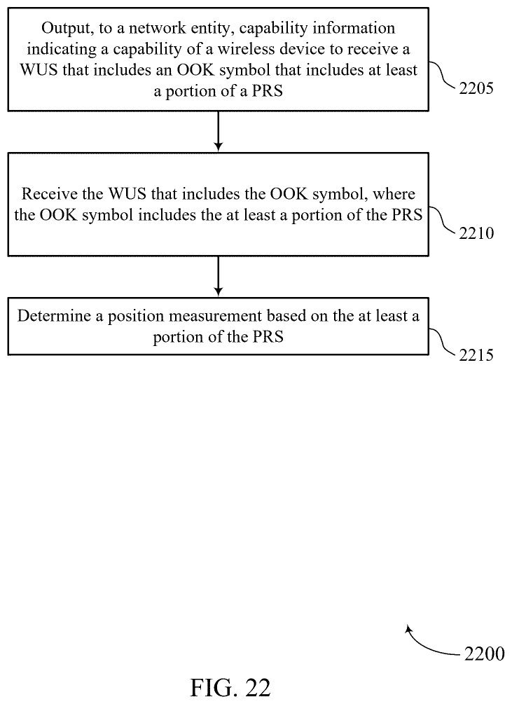

FIG. 22 shows a flowchart illustrating a method 2200 that supports PRSs via WUSs in accordance with one or more aspects of the present disclosure. The operations of the method 2200 may be implemented by a wireless device or its components as described herein. For example, the operations of the method 2200 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

At 2205, the method may include outputting, to a network entity, capability information indicating a capability of a wireless device to receive a WUS that includes an OOK symbol that includes at least a portion of a PRS. The operations of 2205 may be performed in accordance with examples as disclosed herein. In some examples, aspects of the operations of 2205 may be performed by a capability component 1140 as described with reference to FIG. 11.

At 2210, the method may include receiving the WUS that includes the OOK symbol, where the OOK symbol includes at least a portion of the PRS. The operations of 2210 may be performed in accordance with examples as disclosed herein. In some examples, aspects of the operations of 2210 may be performed by a WUS component 1125 as described with reference to FIG. 11.

At 2215, the method may include determining a position measurement based on the at least a portion of the PRS. The operations of 2215 may be performed in accordance with examples as disclosed herein. In some examples, aspects of the operations of 2215 may be performed by a positioning component 1130 as described with reference to FIG. 11.

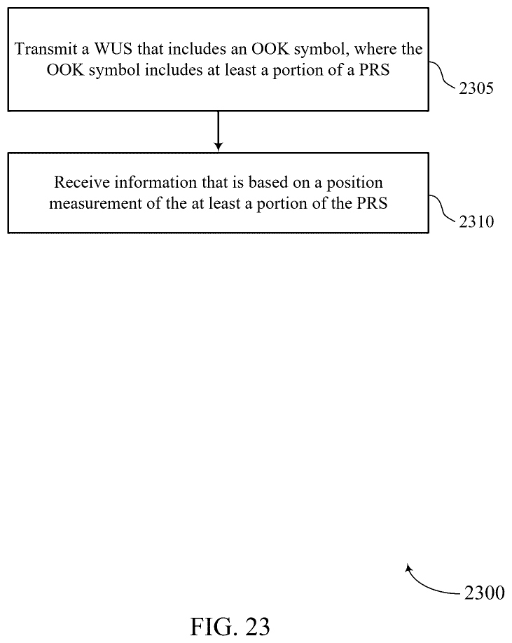

FIG. 23 shows a flowchart illustrating a method 2300 that supports PRSs via WUSs in accordance with one or more aspects of the present disclosure. The operations of the method 2300 may be implemented by a network node or its components as described herein. For example, the operations of the method 2300 may be performed by a network node as described with reference to FIGS. 1 through 8 and 13 through 16. In some examples, a network node may execute a set of instructions to control the functional elements of the network node to perform the described functions. Additionally, or alternatively, the network node may perform aspects of the described functions using special-purpose hardware.

At 2305, the method may include transmitting a WUS that includes an OOK symbol, where the OOK symbol includes at least a portion of a PRS. The operations of 2305 may be performed in accordance with examples as disclosed herein. In some examples, aspects of the operations of 2305 may be performed by a WUS element 1525 as described with reference to FIG. 15.

At 2310, the method may include receiving information that is based on a position measurement of the at least a portion of the PRS. The operations of 2310 may be performed in accordance with examples as disclosed herein. In some examples, aspects of the operations of 2310 may be performed by an information element 1530 as described with reference to FIG. 15.

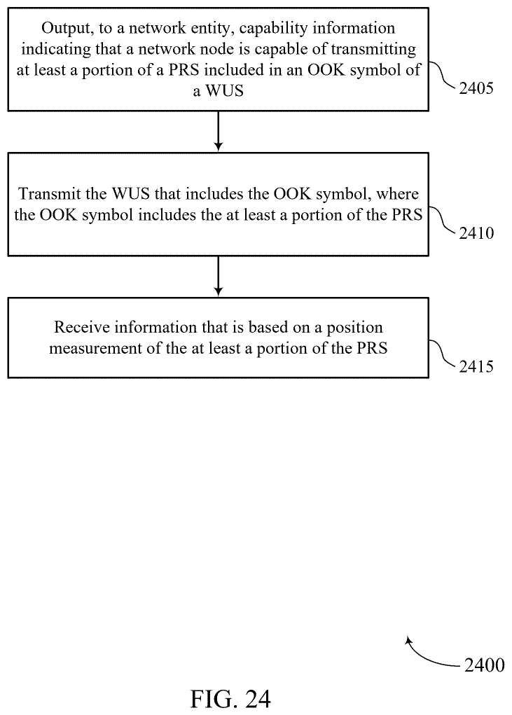

FIG. 24 shows a flowchart illustrating a method 2400 that supports PRSs via WUSs in accordance with one or more aspects of the present disclosure. The operations of the method 2400 may be implemented by a network node or its components as described herein. For example, the operations of the method 2400 may be performed by a network node as described with reference to FIGS. 1 through 8 and 13 through 16. In some examples, a network node may execute a set of instructions to control the functional elements of the network node to perform the described functions. Additionally, or alternatively, the network node may perform aspects of the described functions using special-purpose hardware.

At 2405, the method may include outputting, to a network entity, capability information indicating that a network node is capable of transmitting at least a portion of a PRS included in an OOK symbol of a WUS. The operations of 2405 may be performed in accordance with examples as disclosed herein. In some examples, aspects of the operations of 2405 may be performed by a capability element 1535 as described with reference to FIG. 15.

At 2410, the method may include transmitting the WUS that includes the OOK symbol, where the OOK symbol includes the at least a portion of the PRS. The operations of 2410 may be performed in accordance with examples as disclosed herein. In some examples, aspects of the operations of 2410 may be performed by a WUS element 1525 as described with reference to FIG. 15.

At 2415, the method may include receiving information that is based on a position measurement of the at least a portion of the PRS. The operations of 2415 may be performed in accordance with examples as disclosed herein. In some examples, aspects of the operations of 2415 may be performed by an information element 1530 as described with reference to FIG. 15.

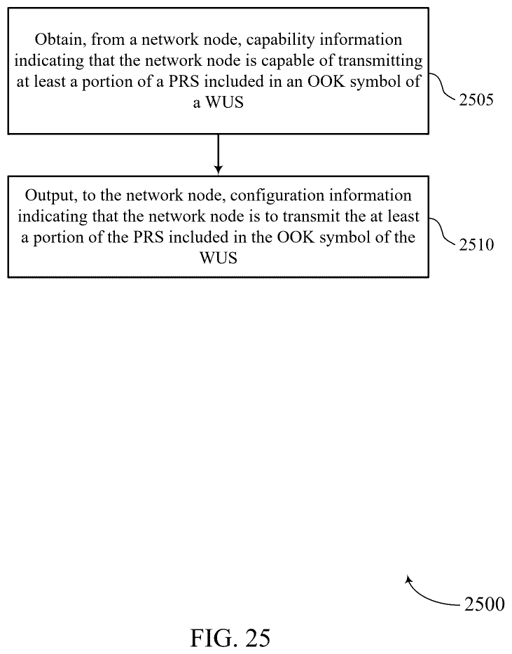

FIG. 25 shows a flowchart illustrating a method 2500 that supports PRSs via WUSs in accordance with one or more aspects of the present disclosure. The operations of the method 2500 may be implemented by a network entity or its components as described herein. For example, the operations of the method 2500 may be performed by a network entity as described with reference to FIGS. 1 through 8 and 17 through 20. In some examples, a network entity may execute a set of instructions to control the functional elements of the network entity to perform the described functions. Additionally, or alternatively, the network entity may perform aspects of the described functions using special-purpose hardware.

At 2505, the method may include obtaining, from a network node, capability information indicating that the network node is capable of transmitting at least a portion of a PRS included in an OOK symbol of a WUS. The operations of 2505 may be performed in accordance with examples as disclosed herein. In some examples, aspects of the operations of 2505 may be performed by a capability manager 1925 as described with reference to FIG. 19.

At 2510, the method may include outputting, to the network node, configuration information indicating that the network node is to transmit the at least a portion of the PRS included in the OOK symbol of a WUS. The operations of 2510 may be performed in accordance with examples as disclosed herein. In some examples, aspects of the operations of 2510 may be performed by a configuration manager 1930 as described with reference to FIG. 19.

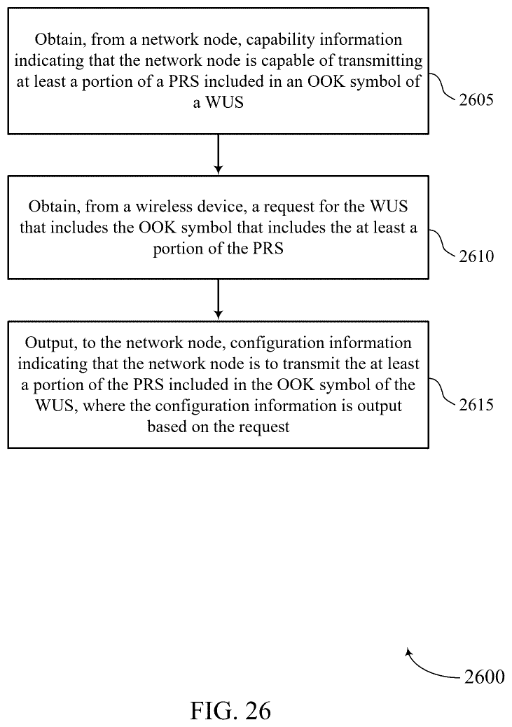

FIG. 26 shows a flowchart illustrating a method 2600 that supports PRSs via WUSs in accordance with one or more aspects of the present disclosure. The operations of the method 2600 may be implemented by a network entity or its components as described herein. For example, the operations of the method 2600 may be performed by a network entity as described with reference to FIGS. 1 through 8 and 17 through 20. In some examples, a network entity may execute a set of instructions to control the functional elements of the network entity to perform the described functions. Additionally, or alternatively, the network entity may perform aspects of the described functions using special-purpose hardware.

At 2605, the method may include obtaining, from a network node, capability information indicating that the network node is capable of transmitting at least a portion of a PRS included in an OOK symbol of a WUS. The operations of 2605 may be performed in accordance with examples as disclosed herein. In some examples, aspects of the operations of 2605 may be performed by a capability manager 1925 as described with reference to FIG. 19.

At 2610, the method may include obtaining, from a wireless device, a request for the WUS that includes the OOK symbol that includes the at least a portion of the PRS. The operations of 2610 may be performed in accordance with examples as disclosed herein. In some examples, aspects of the operations of 2610 may be performed by a request manager 1940 as described with reference to FIG. 19.

At 2615, the method may include outputting, to the network node, configuration information indicating that the network node is to transmit the at least a portion of the PRS included in the OOK symbol of a WUS, where the configuration information is output based on the request. The operations of 2615 may be performed in accordance with examples as disclosed herein. In some examples, aspects of the operations of 2615 may be performed by a configuration manager 1930 as described with reference to FIG. 19.

FIG. 27 shows examples of wireless communications systems 2700 that support PRSs via WUSs in accordance with one or more aspects of the present disclosure. Various positioning techniques are illustrated in the context of the wireless communications systems 2700. Some examples of the positioning procedures described herein may be performed in accordance with one or more aspects of the positioning techniques. While TRPs and UEs are provided in the examples illustrated in FIG. 27, other devices (e.g., network entities, base stations, RRHs, RUs, APs, wireless devices, or stations, among other examples) may be similarly utilized in other examples. The examples of positioning techniques include downlink-based positioning techniques, uplink-based positioning techniques, and downlink-and-uplink-based positioning techniques.

Examples of OTDOA or DL-TDOA 2705 are illustrated in FIG. 27. One or more of the OTDOA or DL-TDOA 2705 positioning techniques may be included in a downlink-b ased positioning procedure. In OTDOA or DL-TDOA 2705 positioning techniques, a UE may measure a difference between TOAs of reference signals (e.g., PRSs) received from one or more pairs of TRPs (e.g., TRP2 and TRP3). In some approaches, a difference in TOAs may be referred to as an RSTD or a TDOA measurement. A positioning device (e.g., the UE, a location server, an LMF, an SLP, or another device) may utilize the differences in TOAs to determine (e.g., estimate) a location of the UE.

In some aspects, the UE may receive an identifier (ID) associated with a reference TRP (e.g., a serving base station) and one or more IDs associated with one or more non-reference TRPs in received data (e.g., assistance data). The UE may measure the difference of TOAs between the reference TRP and each of the non-reference TRPs to produce RSTDs or TDOAs. In some aspects, the UE may report an indication of the RSTDs or TDOAs to the positioning device (e.g., a location server, LMF, an SLP, or another device). Based on established locations of the base stations and the RSTD measurements, the positioning device (e.g., the UE for UE-b ased positioning or a location server for UE-assisted positioning) may estimate the UE's location.

An example of UL-TDOA 2710 is illustrated in FIG. 27. One or more of the UL-TDOA 2710 positioning techniques may be included in an uplink-b ased positioning procedure. UL-TDOA 2710 may have some similarities to DL-TDOA 2705. The UL-TDOA 2710 positioning techniques may be based on uplink reference signals (e.g., SRS) transmitted from the UE to multiple TRPs. For example, the UE transmits one or more uplink reference signals that are measured by a reference TRP (e.g., TRP3) and non-reference TRPs (e.g., TRP1 and TRP2). Each TRP then reports the reception time (which may be referred to as a relative time of arrival (RTOA)) of the reference signal(s) to a positioning device (e.g., a location server, LMF, SLP, or UE) that has information about the locations and relative timing of the TRPs. Based on the reception-to-reception (Rx-Rx) time differences between the reported RTOA of the reference TRP and the reported RTOA of each non-reference TRP, the locations of the TRPs, and the corresponding timing offsets, the positioning device may estimate the location of the UE using TDOA.

An example of DL-AOD 2715 is illustrated in FIG. 27. One or more of the DL-AOD 2715 positioning techniques may be included in a downlink-b ased positioning procedure. In DL-AOD 2715, a UE may obtain received signal strength measurements corresponding to multiple downlink transmit beams for one or more TRPs (e.g., TRP1 and TRP2). In some approaches, the UE reports the measurements to a positioning device. The positioning device may use the signal strength measurements of the multiple downlink transmit beams to determine the angle(s) (e.g., AOD1 and AOD2) between the UE and the transmitting TRP(s). The positioning device (e.g., location server, LMF, SLP, UE, or another device) may estimate the location of the UE based on the determined angle(s) and the established location(s) of the transmitting TRP(s).

An example of UL-AOA 2720 is illustrated in FIG. 27. One or more of the UL-AOA 2720 positioning techniques may be included in an uplink positioning procedure. In UL-AOA 2720, one or more TRPs (e.g., TRP1 and TRP2) measure the received signal strength of one or more uplink reference signals (e.g., SRSs) received from a UE on one or more uplink receive beams. In some aspects, the signal strength measurements may be reported to a positioning device. A positioning device (e.g., LFM, SLP, UE, or another device) may use the signal strength measurements and the angle(s) of the receive beam(s) to determine the angle(s) between the UE and the TRP(s). Based on the determined angle(s) and the established location(s) of the TRP(s), the positioning device may estimate the location of the UE.

Some positioning techniques or procedures may include a combination downlink-based and uplink-based positioning techniques. Examples of downlink-based and uplink-based positioning techniques may include E-CID positioning and multi-round-trip-time (RTT) positioning (which may be referred to as “multi-RTT” or “multi-cell RTT” when multiple cells are utilized).

In multi-RTT, a first device (e.g., a TRP or UE) may transmit a first RTT-related signal (e.g., a PRS or SRS) to a second device (e.g., the UE or TRP). The second device may transmit a second RTT-related signal (e.g., an SRS or PRS) back to the first device. Each device may measure a time difference between the TOA of the received RTT-related signal and the transmission time of the transmitted RTT-related signal. The time difference may be referred to as a reception-to-transmission (Rx-Tx) time difference. In some aspects, the Rx-Tx time difference measurement may be obtained or adjusted to include (e.g., include only) a time difference between nearest slot boundaries for the received and transmitted signals. The first device or the second device may send the corresponding Rx-Tx time difference measurements to a positioning device (e.g., a location server, LMF, SLP, UE, or other device), which may calculate a round trip propagation time (or RTT) between the two device based on the two Rx-Tx time difference measurements (e.g., as a sum of the two Rx-Tx time difference measurements). Additionally, or alternatively, one device may send a corresponding Rx-Tx time difference measurement to the other device, which may calculate the RTT. The distance between the two devices may be determined from the RTT and a signal speed (e.g., the speed of light).

An example of multi-cell RTT 2725 is illustrated in FIG. 27. One or more of the multi-RTT or multi-cell RTT techniques described may be included in an uplink-b ased or downlink-b ased positioning procedure. In multi-cell RTT 2725, a first device (e.g., a UE or TRP) may perform an RTT positioning procedure with multiple second devices (e.g., multiple TRPs or UEs) to enable the location of the first device to be determined (e.g., using multilateration) based on distances to, and the established locations of, the second devices.

In some examples, RTT or multi-RTT techniques may be combined with one or more other positioning techniques (e.g., UL-AOA, DL-AOD, or other positioning techniques), to enhance location accuracy. Examples of combined DL-AOD and RTT 2730 positioning techniques are illustrated in FIG. 27.

E-CID positioning techniques may be based on radio resource management (RRM) measurements. In E-CID, a UE may obtain or report a serving cell ID, a timing advance (TA), identifiers of one or more detected neighbor TRPs, estimated timing of one or more detected neighbor TRPs, or a signal strength measurement of one or more detected neighbor TRPs. A positioning device (e.g., an LFM, SLP, UE, or another device) may utilize the serving cell ID, TA, identifiers, estimated timing, or signal strength measurements with one or more established locations of one or more TRPs to estimate the location of the UE.

In some approaches, a positioning device (e.g., location server, LMF, SLP, or another device) may provide assistance data to the UE. Assistance data is data to assist with one or more positioning operations (e.g., to detect one or more neighboring TRPs or to receive reference signaling). For instance, the assistance data may indicate IDs of the TRPs (e.g., IDs of one or more cells or TRPs corresponding to a network node) from which reference signals may be measured. In some examples, a positioning device may transmit assistance data or other information indicating one or more reference signal configuration parameters. The reference signal configuration parameter(s) may include or indicate a quantity of consecutive slots including PRS, a periodicity of consecutive slots including PRS, a muting sequence, a frequency hopping sequence, a reference signal identifier, a reference signal bandwidth, or one or more other parameters applicable to a positioning technique or procedure. Additionally, or alternatively, the assistance data may be sent from one or more TRPs (e.g., in periodically broadcasted overhead messages, a scheduled message, a unicast message, or a multicast message, among other examples). In some examples, a UE may be able to detect one or more neighboring TRPs (e.g., network entities) without the use of assistance data.

For OTDOA positioning techniques or DL-TDOA positioning techniques, the assistance data may indicate an expected RSTD value and an associated uncertainty or search window around the expected RSTD. For example, an expected RSTD value may have an associated uncertainty or search window with a range of ±500 microseconds (μs). In another example, when any of the resources used for the positioning measurement(s) are in frequency range 1 (FR1), an expected RSTD value may have an associated uncertainty or search window with a range of ±32 μs. In another example, when all of the resources used for the positioning measurement(s) are in frequency range 2 (FR2), an expected RSTD value may have an associated uncertainty or search window with a range of ±8 μs.

In some examples, a location may be referred to as a position estimate, location estimate, position, position fix, or fix, among other examples. A location may be geodetic and include coordinates (e.g., latitude, longitude, or altitude) or may be civic and include a street address, postal address, or another description of a location. In some aspects, a location may be defined relative to another location or may be defined in absolute terms (e.g., latitude, longitude, or altitude). A location may include an indication of error or uncertainty (e.g., by including an area or volume within which the location may be included with a specified or default level of confidence).

Various examples of sidelink positioning techniques are illustrated in FIG. 27. Sidelink positioning techniques may include positioning techniques that are based on sidelink communication (e.g., based exclusively on sidelink communication or based on sidelink communication jointly with other communication(s), such as Uu interface communication).

A first example of sidelink positioning 2735 is illustrated in FIG. 27. In the first example of sidelink positioning 2735, at least one peer UE with an established location may improve location estimation (e.g., Uu-b ased positioning, multi-cell RTT, DL-TDOA, or UL-TDOA, among other examples) for a target UE by providing an additional anchor (e.g., sidelink RTT (SL-RTT)).

A second example of sidelink positioning 2740 is illustrated in FIG. 27. In the second example of sidelink positioning 2740, different types (e.g., categories, classes, or capabilities) of UEs may be utilized. For example, first UEs and a second UE may be utilized. Relative to the second UE, the first UEs may have one or more increased capabilities, such as one or more additional sensors, a faster processor, greater memory capacity, one or more additional antenna elements, a higher transmit power capability, access to one or more additional frequency bands, or any combination thereof. In some aspects, the second UE may be a reduced capacity or “RedCap” UE. The second UE may be assisted by the first UEs to determine the location of the second UE. For instance, sidelink-b ased positioning or ranging procedures may be performed with the first UEs, which may enhance the location accuracy of the second UE.

A third example of sidelink positioning 2745 is illustrated in FIG. 27. The third example of sidelink positioning 2745 may be performed via one or more sidelink connections (e.g., via sidelink connections exclusively or jointly with one or more Uu-b ased connections). In the third example of sidelink positioning 2745, the UEs may perform peer-to-peer (P2P) positioning or ranging. Sidelink positioning may be helpful for out-of-coverage or public safety scenarios. For instance, the UEs may be out of coverage of a network and may determine a location or a relative distance and a relative position among the UEs using sidelink positioning techniques. In some examples, sidelink positioning may be performed by UEs in public safety scenarios (e.g., for police, firefighters, search-and-rescue, or paramedics, among other examples).

A fourth example of sidelink positioning 2750 is illustrated in FIG. 27. The fourth example of sidelink positioning 2750 may be performed via one or more sidelink connections (e.g., via sidelink connections exclusively or jointly with one or more Uu-b ased connections). In the fourth example of sidelink positioning 2750, one or more of the UEs may determine a location or a relative distance and a relative position using sidelink positioning techniques, such as SL-RTT. For instance, one or more of the UEs may be out of coverage of a network and may determine a location or a relative distance and a relative position among the UEs using sidelink positioning techniques.

An example of relay positioning 2755 is illustrated in FIG. 27. In the example of relay positioning 2755, a relay UE (e.g., with an established location) may participate in the location estimation of a remote UE (without performing uplink reference signal transmission over the Uu interface, for instance). For example, the relay UE may receive a downlink PRS from a TRP and may relay an SL-PRS to the remote UE. In some cases, the remote UE may also receive another downlink PRS from the TRP. A positioning device (e.g., location server, LMF, SLP, UE, or other device) may utilize a downlink PRS measurement and an SL-PRS measurement with the established location of the relay UE to estimate the location of the remote UE.

An example of joint positioning 2760 is illustrated in FIG. 27. In the example of joint positioning 2760, multiple peer UEs (without established locations, for instance) may be located. In some approaches, multiple peer UEs may be jointly located in NLOS conditions by utilizing one or more constraints from one or more peer (e.g., neighboring or nearby) UEs. As illustrated in FIG. 27, RTT or TDOA techniques may be performed between TRP1 and each of the peer UEs, may be performed between TRP2 and each of the peer UEs, and may be performed between the peer UEs. In some examples, one or more of the peer UEs may report measurements from the RTT or TDOA technique(s) to a positioning device. The positioning device (e.g., location server, LMF, SLP, UE, or other device) may utilize the measurements from the RTT or TDOA technique(s) to estimate the locations of the peer UEs.

Some aspects of the techniques described herein may be performed in conjunction with one or more of the positioning techniques described with reference to FIG. 27. For instance, one or more samples of a signal (e.g., PRS, SRS, or other signal) may be measured or transmitted in accordance with one or more of the techniques described with reference to FIG. 4 for one or more of the positioning techniques.

The following provides an overview of aspects of the present disclosure:
Aspect 1: A method for wireless communications by a wireless device, comprising: receiving a WUS that includes an OOK symbol, wherein the OOK symbol comprises at least a portion of a PRS; and determining a position measurement based at least in part on the at least a portion of the PRS.
Aspect 2: The method of aspect 1, wherein participating in the positioning procedure comprises: generating information based at least in part on the position measurement of the at least a portion of the PRS; and transmitting, to a network entity, the information that is based at least in part on the position measurement of the PRS.
Aspect 3: The method of any of aspects 1 through 2, wherein the at least a portion of the PRS is carried on one or more OOK symbols with an on state in a duration of an OFDM symbol.
Aspect 4: The method of any of aspects 1 through 3, wherein the OOK symbol has a same duration as an OFDM symbol, and the at least a portion of the PRS is modulated in a frequency domain on one or more subcarriers for the WUS.
Aspect 5: The method of any of aspects 1 through 3, wherein the OOK symbol has a shorter duration than an OFDM symbol, and the at least a portion of the PRS is a signal generated in a time domain.
Aspect 6: The method of any of aspects 1 through 3 and 5, wherein the OOK symbol has a shorter duration than an OFDM symbol, and the at least a portion of the PRS is modulated in a frequency domain with a first SCS that is M times a second SCS of the OFDM symbol.
Aspect 7: The method of any of aspects 1 through 6, wherein multiple PRSs are time-division multiplexed in the WUS or across multiple WUSs.
Aspect 8: The method of aspect 7, wherein a first PRS of the multiple PRSs corresponds to a first cell and a second PRS of the multiple PRSs corresponds to a second cell, the first PRS is communicated via a first quantity of OOK symbols and the second PRS is communicated via a second quantity of OOK symbols that is different from the first quantity of symbols.
Aspect 9: The method of any of aspects 1 through 8, wherein the at least a portion of the PRS spans a single OOK symbol, multiple OOK symbols, or all OOK symbols of the WUS.
Aspect 10: The method of any of aspects 1 through 9, wherein the at least a portion of the PRS is frequency-division multiplexed on the WUS in accordance with a comb.
Aspect 11: The method of any of aspects 1 through 10, wherein a resource for communication of PRS signaling repeats based at least in part on a quantity of OOK symbols, a quantity of OFDM symbols, a quantity of slots, or a quantity of WUS repetitions.
Aspect 12: The method of any of aspects 1 through 11, further comprising: outputting, to a network entity, a request for the WUS that includes the OOK symbol that comprises the at least a portion of the PRS, wherein the WUS is received based at least in part on the request.

Aspect 13: The method of any of aspects 1 through 12, further comprising: outputting, to a network entity, capability information indicating a capability of the wireless device to receive the WUS that includes the OOK symbol that comprises the at least a portion of the PRS.

Aspect 14: The method of any of aspects 1 through 13, further comprising: obtaining, from a network entity, configuration information indicating that the wireless device is to receive the WUS that includes the OOK symbol that comprises the at least a portion of the PRS.
Aspect 15: A method for wireless communications by a network node, comprising: transmitting a WUS that includes an OOK symbol, wherein the OOK symbol comprises at least a portion of a PRS; and receiving information that is based at least in part on a position measurement of the at least a portion of the PRS.
Aspect 16: The method of aspect 15, wherein the at least a portion of the PRS is carried on one or more OOK symbols with an on state in a duration of an OFDM symbol.
Aspect 17: The method of any of aspects 15 through 16, wherein the OOK symbol has a same duration as an OFDM symbol, and the at least a portion of the PRS is modulated in a frequency domain on one or more subcarriers for the WUS.
Aspect 18: The method of any of aspects 15 through 16, wherein the OOK symbol has a shorter duration than an OFDM symbol, and the at least a portion of the PRS is a signal generated in a time domain.
Aspect 19: The method of any of aspects 15 through 16 and 18, wherein the OOK symbol has a shorter duration than an OFDM symbol, and the at least a portion of the PRS is modulated in a frequency domain with a first SCS that is M times a second SCS of the OFDM symbol.
Aspect 20: The method of any of aspects 15 through 19, wherein multiple PRSs are time-division multiplexed in the WUS or across multiple WUSs.
Aspect 21: The method of aspect 20, wherein a first PRS of the multiple PRSs corresponds to a first cell and a second PRS of the multiple PRSs corresponds to a second cell, the first PRS is communicated via a first quantity of OOK symbols and the second PRS is communicated via a second quantity of OOK symbols that is different from the first quantity of symbols.
Aspect 22: The method of any of aspects 15 through 21, wherein the at least a portion of the PRS spans a single OOK symbol, multiple OOK symbols, or all OOK symbols of the WUS.
Aspect 23: The method of any of aspects 15 through 22, wherein the at least a portion of the PRS is frequency-division multiplexed on the WUS in accordance with a comb.
Aspect 24: The method of any of aspects 15 through 23, wherein a resource for communication of PRS signaling repeats based at least in part on a quantity of OOK symbols, a quantity of OFDM symbols, a quantity of slots, or a quantity of WUS repetitions.
Aspect 25: The method of any of aspects 15 through 24, further comprising: outputting, to a network entity, capability information indicating that the network node is capable of transmitting the at least a portion of the PRS (included in or overlaid with the OOK symbol of the WUS, for instance).
Aspect 26: The method of any of aspects 15 through 25, further comprising: outputting, to a network entity, an indication of a periodicity of PRS signaling on WUS signaling that the network node is capable of transmitting, an indication of a type of PRS signaling on WUS signaling that the network node is capable of transmitting, a bandwidth of PRS signaling on WUS signaling that the network node supports, a duration of WUS signaling via which PRS signaling is supported by the network node, an indication of one or more activity modes the network node supports for PRS signaling on WUS signaling, or an indication of whether PRS signaling on WUS signaling during a CDRX is supported by the network node, or any combination thereof.
Aspect 27: The method of any of aspects 15 through 26, further comprising: obtaining, from a network entity, a request for an indication of a pattern of the WUS corresponding to a wireless device; and outputting, to the network entity, the indication of the pattern of the WUS corresponding to the wireless device based at least in part on the request.
Aspect 28: The method of any of aspects 15 through 27, further comprising: obtaining, from a network entity, a request that the network node transmit the at least a portion of the PRS (included in or overlaid with the OOK symbol, for instance) in accordance with a pattern, wherein transmitting the WUS that includes the OOK symbol is based at least in part on the pattern.
Aspect 29: A method for wireless communications by a network entity, comprising: obtaining, from a network node, capability information indicating that the network node is capable of transmitting at least a portion of a PRS included in an OOK symbol of a WUS; and outputting, to the network node, configuration information indicating that the network node is to transmit the at least a portion of the PRS included in the OOK symbol of a WUS.
Aspect 30: The method of aspect 29, further comprising: receiving information that is based at least in part on a position measurement of the at least a portion of the PRS.
Aspect 31: The method of any of aspects 29 through 30, wherein the capability information comprises an indication of a periodicity of PRS signaling on WUS signaling that the network node is capable of transmitting, an indication of a type of PRS signaling on WUS signaling that the network node is capable of transmitting, a bandwidth of PRS signaling on WUS signaling that the network node supports, a duration of WUS signaling via which PRS signaling is supported by the network node, an indication of one or more activity modes the network node supports for PRS signaling on WUS signaling, or an indication of whether PRS signaling on WUS signaling during a CDRX is supported by the network node, or any combination thereof, and the configuration information is based at least in part on the capability information.
Aspect 32: The method of any of aspects 29 through 31, further comprising: outputting, to the network node, a request for an indication of a pattern of the WUS corresponding to a wireless device; and obtaining, from the network node, the indication of the pattern of the WUS corresponding to the wireless device based at least in part on the request.
Aspect 33: The method of any of aspects 29 through 32, further comprising: outputting, to the network node, a request that the network node transmit the at least a portion of the PRS in accordance with a pattern.
Aspect 34: The method of any of aspects 29 through 33, further comprising: obtaining, from a wireless device, a request for the WUS that includes the OOK symbol that comprises the at least a portion of the PRS, wherein the configuration information is output based at least in part on the request.
Aspect 35: The method of any of aspects 29 through 34, further comprising: obtaining, from a wireless device, capability information indicating a capability of the wireless device to receive the WUS that includes the OOK symbol that comprises the at least a portion of the PRS.
Aspect 36: The method of any of aspects 29 through 35, further comprising: outputting, to a wireless device, configuration information indicating that the wireless device is to receive the WUS that includes the OOK symbol that comprises the at least a portion of the PRS.
Aspect 37: A wireless device comprising one or more transceivers, one or more memory, and one or more processors coupled to the one or more memory and the one or more transceivers. The one or more processors may be configured to perform a method of any of aspects 1 through 14.
Aspect 38: A wireless device comprising at least one means for performing a method of any of aspects 1 through 14.
Aspect 39: A non-transitory computer-readable medium storing code the code comprising instructions executable by one or more processors to perform a method of any of aspects 1 through 14.
Aspect 40: A network node comprising one or more transceivers, one or more memory, and one or more processors coupled to the one or more memory and the one or more transceivers. The one or more processors may be configured to perform a method of any of aspects 15 through 28.
Aspect 41: A network node comprising at least one means for performing a method of any of aspects 15 through 28.
Aspect 42: A non-transitory computer-readable medium storing code the code comprising instructions executable by one or more processors to perform a method of any of aspects 15 through 28.
Aspect 43: A network entity comprising one or more transceivers, one or more memory, and one or more processors coupled to the one or more memory and the one or more transceivers. The one or more processors may be configured to perform a method of any of aspects 29 through 36.
Aspect 44: A network entity comprising at least one means for performing a method of any of aspects 29 through 36.
Aspect 45: A non-transitory computer-readable medium storing code the code comprising instructions executable by one or more processors to perform a method of any of aspects 29 through 36.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more transceivers;
one or more memory; and
one or more processors electronically coupled to the one or more memory and the one or more transceivers, the one or more processors configured to:
receive a wake-up signal (WUS) that includes an on-off keying (OOK) symbol, wherein the OOK symbol comprises at least a portion of a positioning reference signal (PRS); and
determine a position measurement based at least in part on the at least a portion of the PRS.

2. The wireless device of claim 1, wherein the one or more processors are configured to:
generate information based at least in part on the position measurement of the at least a portion of the PRS; and
transmit, to a network entity, the information that is based at least in part on the position measurement of the PRS.

3. The wireless device of claim 1, wherein the at least a portion of the PRS is carried on one or more OOK symbols with an on state in a duration of an orthogonal frequency division multiplexing (OFDM) symbol.

4. The wireless device of claim 1, wherein the OOK symbol has a same duration as an orthogonal frequency division multiplexing (OFDM) symbol, and the at least a portion of the PRS is modulated in a frequency domain on one or more subcarriers for the WUS.

5. The wireless device of claim 1, wherein the OOK symbol has a shorter duration than an orthogonal frequency division multiplexing (OFDM) symbol, and the at least a portion of the PRS is a signal generated in a time domain.

6. The wireless device of claim 1, wherein the OOK symbol has a shorter duration than an orthogonal frequency division multiplexing (OFDM) symbol, and the at least a portion of the PRS is modulated in a frequency domain with a first subcarrier spacing (SCS) that is M times a second SCS of the OFDM symbol.

7. The wireless device of claim 1, wherein multiple PRSs are time-division multiplexed in the WUS or across multiple WUSs.

8. The wireless device of claim 7, wherein a first PRS of the multiple PRSs corresponds to a first cell and a second PRS of the multiple PRSs corresponds to a second cell, wherein the first PRS is communicated via a first quantity of OOK symbols and the second PRS is communicated via a second quantity of OOK symbols that is different from the first quantity of symbols.

9. The wireless device of claim 1, wherein the at least a portion of the PRS spans a single OOK symbol, multiple OOK symbols, or all OOK symbols of the WUS.

10. The wireless device of claim 1, wherein the at least a portion of the PRS is frequency-division multiplexed on the WUS in accordance with a comb.

11. The wireless device of claim 1, wherein a resource for communication of PRS signaling repeats based at least in part on a quantity of OOK symbols, a quantity of orthogonal frequency-division multiplexing (OFDM) symbols, a quantity of slots, or a quantity of WUS repetitions.

12. The wireless device of claim 1, wherein the one or more processors are further configured to:
output, to a network entity, a request for the WUS that includes the OOK symbol that comprises the at least a portion of the PRS, wherein the WUS is received based at least in part on the request.

13. The wireless device of claim 1, wherein the one or more processors are further configured to:
output, to a network entity, capability information indicating a capability of the wireless device to receive the WUS that includes the OOK symbol that comprises the at least a portion of the PRS.

14. The wireless device of claim 1, wherein the one or more processors are further configured to:
obtain, from a network entity, configuration information indicating that the wireless device is to receive the WUS that includes the OOK symbol that comprises the at least a portion of the PRS.

15. A network node, comprising:
one or more transceivers;
one or more memory; and
one or more processors electronically coupled to the one or more memory and the one or more transceivers, the one or more processors configured to:
transmit a wake-up signal (WUS) that includes an on-off keying (OOK) symbol, wherein the OOK symbol comprises at least a portion of a positioning reference signal (PRS); and
receive information that is based at least in part on a position measurement of the at least a portion of the PRS.

16. The network node of claim 15, wherein a resource for communication of PRS signaling repeats based at least in part on a quantity of OOK symbols, a quantity of orthogonal frequency-division multiplexing (OFDM) symbols, a quantity of slots, or a quantity of WUS repetitions.

17. The network node of claim 15, wherein the one or more processors are further configured to:
output, to a network entity, capability information indicating that the network node is capable of transmitting the at least a portion of the PRS included in the OOK symbol of the WUS.

18. The network node of claim 15, wherein the one or more processors are further configured to:
output, to a network entity, an indication of a periodicity of PRS signaling on WUS signaling that the network node is capable of transmitting, an indication of a type of PRS signaling on WUS signaling that the network node is capable of transmitting, a bandwidth of PRS signaling on WUS signaling that the network node supports, a duration of WUS signaling via which PRS signaling is supported by the network node, an indication of one or more activity modes the network node supports for PRS signaling on WUS signaling, or an indication of whether PRS signaling on WUS signaling during a connected mode discontinuous reception (CDRX) is supported by the network node, or any combination thereof.

19. The network node of claim 15, wherein the one or more processors are further configured to:
obtain, from a network entity, a request for an indication of a pattern of the WUS corresponding to a wireless device; and
output, to the network entity, the indication of the pattern of the WUS corresponding to the wireless device based at least in part on the request.

20. The network node of claim 15, wherein the one or more processors are further configured to:
obtain, from a network entity, a request that the network node transmit the at least a portion of the PRS in accordance with a pattern, wherein transmitting the WUS that includes the OOK symbol is based at least in part on the pattern.

21. A network entity, comprising:
one or more transceivers;
one or more memory; and
one or more processors electronically coupled to the one or more memory and the one or more transceivers, the one or more processors configured to:
obtain, from a network node, capability information indicating that the network node is capable of transmitting at least a portion of a positioning reference signal (PRS) included in an on-off keying (OOK) symbol of a wake-up signal (WUS); and
output, to the network node, configuration information indicating that the network node is to transmit the at least a portion of the PRS included in the OOK symbol of the WUS.

22. The network entity of claim 21, wherein the one or more processors are further configured to:
receive information that is based at least in part on a position measurement of the at least a portion of the PRS.

23. The network entity of claim 21, wherein:
the capability information comprises an indication of a periodicity of PRS signaling on WUS signaling that the network node is capable of transmitting, an indication of a type of PRS signaling on WUS signaling that the network node is capable of transmitting, a bandwidth of PRS signaling on WUS signaling that the network node supports, a duration of WUS signaling via which PRS signaling is supported by the network node, an indication of one or more activity modes the network node supports for PRS signaling on WUS signaling, or an indication of whether PRS signaling on WUS signaling during a connected mode discontinuous reception (CDRX) is supported by the network node, or any combination thereof, and
the configuration information is based at least in part on the capability information.

24. The network entity of claim 21, wherein the one or more processors are further configured to:
output, to the network node, a request for an indication of a pattern of the WUS corresponding to a wireless device; and
obtain, from the network node, the indication of the pattern of the WUS corresponding to the wireless device based at least in part on the request.

25. The network entity of claim 21, wherein the one or more processors are further configured to:
output, to the network node, a request that the network node transmit the at least a portion of the PRS in accordance with a pattern.

26. The network entity of claim 21, wherein the one or more processors are further configured to:
obtain, from a wireless device, a request for the WUS that includes the OOK symbol that comprises the at least a portion of the PRS, wherein the configuration information is output based at least in part on the request.

27. The network entity of claim 21, wherein the one or more processors are further configured to:
obtain, from a wireless device, capability information indicating a capability of the wireless device to receive the WUS that includes the OOK symbol that comprises the at least a portion of the PRS.

28. The network entity of claim 21, wherein the one or more processors are further configured to:
output, to a wireless device, configuration information indicating that the wireless device is to receive the WUS that includes the OOK symbol that comprises the at least a portion of the PRS.

29. A method for wireless communications by a wireless device, comprising:
receiving a wake-up signal (WUS) that includes an on-off keying (OOK) symbol, wherein the OOK symbol comprises at least a portion of a positioning reference signal (PRS); and
determining a position measurement based at least in part on the at least a portion of the PRS.

30. The method of claim 29, further comprising:
generating information based at least in part on the position measurement of the at least a portion of the PRS; and
transmitting, to a network entity, the information that is based at least in part on the position measurement of the PRS.
